(19) United States
(12) Patent Application Publication
(10) Pub. No.: US 2014/0370961 A1
(43) Pub. Date: Dec. 18, 2014

(54) SYSTEMS AND METHODS FOR A BONUS GAME

(71) Applicant: Gamesys Ltd, London (GB)

(72) Inventors: Hans Elias, Hertfordshire (GB); Thomas David James Aicken, London (GB); Alexander Sandford Todd Young, London (GB)

(21) Appl. No.: 14/302,599

(22) Filed: Jun. 12, 2014

Related U.S. Application Data
(60) Provisional application No. 61/834,411, filed on Jun. 12, 2013.

(51) Int. Cl. G07F 17/34; G07F 17/32

(52) U.S. Cl. CPC G07F 17/34; G07F 17/3213
USPC 463/20

(57) ABSTRACT

Systems, methods, and articles of manufacture provide for bonus symbols and/or other reel symbols in a slot-style game that may be associated with (e.g., functionally connected to) a plurality of bonus areas or elements. In some embodiments, each reel of a slot-style game may be specifically associated with and/or tied-to one of the bonus areas or elements. According to some embodiments, values and/or parameters associated with and/or assigned to the plurality of bonus areas and/or elements may be adjusted by a player in connection with initiation and/or play of a bonus game. According to some embodiments, the bonus areas/elements may be presented and/or configured as “trap doors” having values that can fall through the doors when opened, and thus disappear (e.g., be deleted or cleared).

### CROSS-REFERENCE TO RELATED APPLICATIONS

This application claims benefit and priority to, and is a non-provisional of, U.S. Provisional Patent Application No. 61/834,411 filed on Jun. 12, 2013 and titled “METHODS AND SYSTEMS FOR A BONUS ROUND OF A GAME WHICH PROVIDES FOR PLAYER DISTRIBUTION OF ACCUMULATED VALUE”, the entirety of which is hereby incorporated by reference herein.

### COPYRIGHT NOTICE

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### BACKGROUND

Game play and gaming tournaments for various types of games such as online, offline, skill-based, games of chance, and games of mixed skill and chance are a continued source of entertainment to game players, and are often a source of great revenue for gaming companies. Accordingly, there is a desire to provide players with increasingly newer, more interesting, engaging, or entertaining games.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a block diagram of a system according to some embodiments;

FIG. 4 is a block diagram of a system according to some embodiments;

FIG. 5 is a block diagram of a system according to some embodiments;

FIG. 6 is a flow diagram of a method according to some embodiments;

FIG. 7A, FIG. 7B, FIG. 7C, FIG. 7D, FIG. 7E, FIG. 7F, FIG. 7G, and FIG. 7H are block diagrams of an example game interface according to some embodiments;

FIG. 8 is a block diagram of an apparatus according to some embodiments; and

FIG. 9A, FIG. 9B, FIG. 9C, FIG. 9D, and FIG. 9E are perspective diagrams of exemplary data storage devices according to some embodiments.

### DETAILED DESCRIPTION

### I. Introduction

Embodiments presented herein are descriptive of systems, apparatus, methods, and articles of manufacture for bonus games. In some embodiments, bonus symbols and/or other reel symbols in a slot-style game may be associated with (e.g., functionally connected to) a plurality of bonus areas or elements. In some embodiments, each reel of a slot-style game may be specifically associated with and/or tied-to one of the bonus areas or elements. According to some embodiments, values and/or parameters associated with and/or assigned to the plurality of bonus areas and/or elements may be adjusted by a player in connection with initiation and/or play of a bonus game. According to some embodiments, the bonus areas/elements may be presented and/or configured as “trap doors” having values that can fall through the doors when opened, and thus disappear (e.g., be deleted or cleared).

### II. Terms and Definitions

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

A “game”, as the term is used herein (unless specified otherwise), may generally comprise any game (e.g., wagering or non-wagering, electronically playable over a network) playable by one or more players in accordance with specified rules. A game may be playable on a Personal Computer (PC) online in web browsers, on a game console and/or on a mobile device such as a smart-phone or tablet computer. “Gaming” thus generally refers to play of a game.

A “casual game”, as the term is used herein (unless specified otherwise), may generally comprise a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as used herein (unless specified otherwise), generally refers to a type of online game that is played through a social network, and in some embodiments may feature multiplayer and asynchronous game play mechanics. A “social network” may refer to an online service, online community, platform, or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a browser game, but can also be implemented on other platforms such as mobile devices.

A “wagering game”, as the term is used herein (unless specified otherwise), may generally comprise a game on which a player can risk a wager or other consideration, such as, but not limited to: slot games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” generally refers to play of a wagering game.

The term “game provider”, as used herein (unless specified otherwise), generally refers to an entity or system of components which provides games for play and facilitates play of such game by use of a network such as the Internet or a proprietary or closed networks (e.g., an intranet or wide area network). For example, a game provider may operate a website which provides games in a digital format over the Internet. In some embodiments in which a game comprising a wagering game is provided, a game provider may operate a gambling website over which wagers are accepted and results of wagering games are provided.

As utilized herein, the term “player” may generally refer to any type, quantity, and or manner of entity associated with the play of a game. In some embodiments, a player may comprise an entity conducting play of an online game, for example, may comprise an entity that desires to play a game (e.g., an entity registered and/or scheduled to play and/or an entity having expressed interest in the play of the game—e.g., a spectator) and/or may comprise an entity that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game). In some embodiments, a player may comprise an individual (or group) that enters, joins, logs into, registers for, and/or otherwise access an online game room, session, server, and/or other particular instance and/or segmentation of an online game.

Some embodiments described herein are associated with a “player device” or a “network device”. As used herein, a “player device” is a subset of a “network device”. The “network device”, for example, may generally refer to any device that can communicate via a network, while the “player device” may comprise a network device that is owned and/or operated by or otherwise associated with a player. Examples of player and/or network devices may include, but are not limited to: a PC, a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

As used herein, the term “network component” may refer to a player or network device, or a component, piece, portion, or combination of player or network devices. Examples of network components may include a Static Random Access Memory (SRAM) device or module, a network processor, and a network communication path, connection, port, or cable.

In addition, some embodiments are associated with a “network” or a “communication network.” As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

The term “indication”, as used herein (unless specified otherwise), may generally refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

A “session”, as the term is used herein (unless indicated otherwise), may generally comprise a period of time spanning a plurality of event instances or turns of a game, the session having a defined start and defined end. An event instance or turn is triggered upon an initiation of, or request for, at least one result of the game by a player, such as an actuation of a “start” or “spin” mechanism, which initiation causes an outcome to be determined or generated (e.g., a random number generator is contacted or communicated with to identify, generate or determine a random number to be used to determine a result for the event instance). In some embodiments, a session may initiate upon a player providing and/or inputting (and an associated gaming device accordingly receiving) one or more identifiers and/or credentials (e.g., logging-in) and/or may end or terminate upon a logging-out of the player (either explicitly or implicitly—such as by ceasing play, running out of credits/spins, and/or becoming inactive for more than a threshold period of time).

As used herein, the terms “outcome” and “result” should be differentiated in the present description in that an “outcome” is generally a representation of a “result”, typically comprising one or more game elements or game symbols. For example, in a “fruit themed” game, a winning outcome (i.e., an outcome corresponding to some kind of award, prize or payout) may comprise a combination of three “cherry” symbols. The “result” of this outcome may be a payout of X credits awarded to the player associated with the game. In another example, in a game in which a character moves along a game interface from a starting position to a finish position, an “outcome” of the game may comprise a symbol representing one or more movements along the interface and the “result” corresponding to this outcome may be the particular number and direction of the character's movement (e.g., three (3) spaces backwards such that the character ends up further away from the finish line). In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass awards, prizes and payouts which are monetary, non-monetary, tangible or intangible.

As used herein, the term “virtual currency” may generally refer to an in-game currency that may be used as part of a game or one or more games provided by a game provider as (i) currency for making wagers, and/or (ii) to purchase or access various in-game items, features or powers.

A “credit balance”, as the term is used herein (unless indicated otherwise), may generally refer to (i) a balance of currency, whether virtual currency and/or real currency, usable for making wagers in a game and/or (ii) another tracking mechanism for tracking a player's success or advancement in a game by deducting there from points or value for unsuccessful attempts at advancement and adding thereto points or value for successful attempts at advancement.

Some embodiments are descriptive of an “array” or “matrix” of symbols or game outcomes. As utilized herein, the terms “array” and “matrix” generally refer to a group of symbols, numbers, and/or expressions arranged in a plurality of rows and columns (or that can be readily and appropriately represented mathematically as being so arranged). In some embodiments, the term “array” is utilized to refer to a multi-dimensional matrix or combination of matrices while the term “matrix” is utilized to refer to a two-dimensional set of symbols or numbers (e.g., slot reel symbols and/or mathematical representations thereof). According to some embodiments, such as in the case that an array and/or matrix is populated with graphical game symbols, the array or matrix may be output and/or displayed (e.g., transmit to and/or rendered on a player device) as part of a game session.

### III. Embodiments

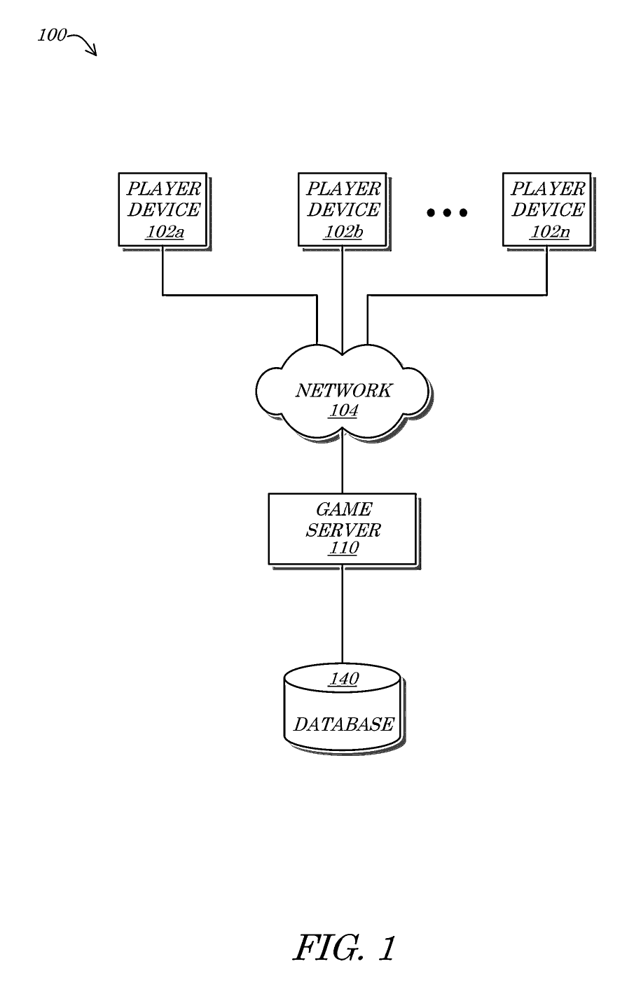

Turning first to FIG. 1, a block diagram of a system 100 according to some embodiments is shown. In some embodiments, the system 100 may comprise a gaming platform such as a gaming platform via which one or more multiplayer, casual, social network, wagering, slot-style, and/or online games may be played. In some embodiments, the system 100 may comprise a plurality of player devices 102a-n in communication with and/or via a network 104. In some embodiments, a game server 110 may be in communication with the network 104 and/or one or more of the player devices 102a-n. In some embodiments, the game server 110 (and/or the player devices 102a-n) may be in communication with a database 140. The database 140 may store, for example, game date (e.g., processed and/or defined by the game server 110), data associated with players (not explicitly shown) owning and/or operating the player devices 102a-n, and/or instructions that cause various devices (e.g., the game server 110 and/or the player devices 102a-n) to operate in accordance with embodiments described herein (e.g., to provide a slot-style game having reel-tied bonus areas and/or player-adjustable bonus value distributions as described herein).

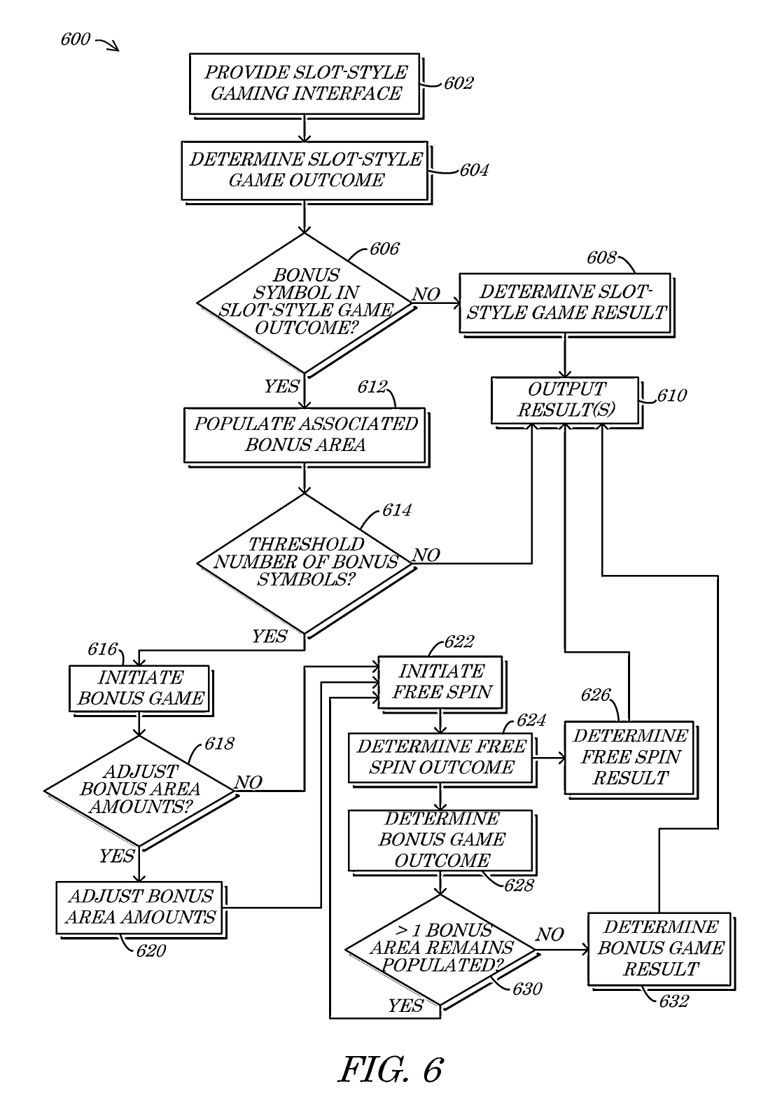

According to some embodiments, any or all of the components 102a-n, 104, 110, 140 of the system 100 may be similar in configuration and/or functionality to any similarly named and/or numbered components described herein. Fewer or more components 102a-n, 104, 110, 140 (and/or portions thereof) and/or various configurations of the components 102a-n, 104, 110, 140 may be included in the system 100 without deviating from the scope of embodiments described herein. While multiple instances of some components 102a-n are depicted and while single instances of other components 104, 110, 140 are depicted, for example, any component 102a-n, 104, 110, 140 depicted in the system 100 may comprise a single device, a combination of devices and/or components 102a-n, 104, 110, 140, and/or a plurality of devices, as is or becomes desirable and/or practicable. Similarly, in some embodiments, one or more of the various components 102a-n, 104, 110, 140 may not be needed and/or desired in the system 100. In some embodiments, the system 100 may be configured and/or utilized to implement and/or facilitate the method 600 of FIG. 6, or one or more portions thereof.

The player devices 102a-n, in some embodiments, may comprise any type or configuration of electronic, mobile electronic, and or other network and/or communication devices (or combinations thereof) that are or become known or practicable. A first player device 102a may, for example, comprise one or more PC devices, computer workstations (e.g., game consoles and/or gaming computers), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, one or more of the player devices 102a-n may be specifically utilized and/or configured (e.g., via specially-programmed and/or stored instructions such as may define or comprise a software application) to communicate with the game server 110 (e.g., via the network 104).

The network 104 may, according to some embodiments, comprise a LAN, WAN, cellular telephone network, Bluetooth® network, NFC network, and/or RF network with communication links between the player devices 102a-n, the game server 110, and/or the database 140. In some embodiments, the network 104 may comprise direct communications links between any or all of the components 102a-n, 110, 140 of the system 100. The game server 110 may, for example, be directly interfaced or connected to the database 140 via one or more wires, cables, wireless links, and/or other network components, such network components (e.g., communication links) comprising portions of the network 104. In some embodiments, the network 104 may comprise one or many other links or network components other than those depicted in FIG. 1. A second player device 102b may, for example, be connected to the game server 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 110, 140 of the system 100. The network 104 may comprise one or more cellular telephone networks with communication links between the player devices 102a-n and the game server 110, for example, and/or may comprise the Internet, with communication links between the player devices 102a-n and the database 140, for example.

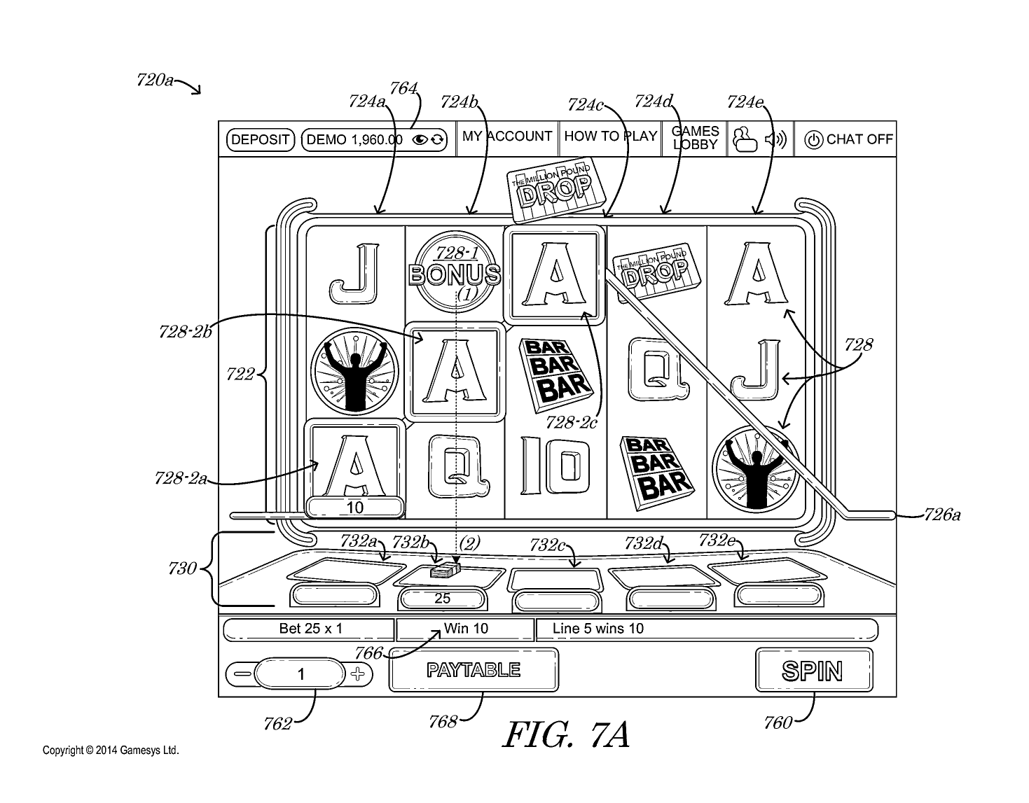

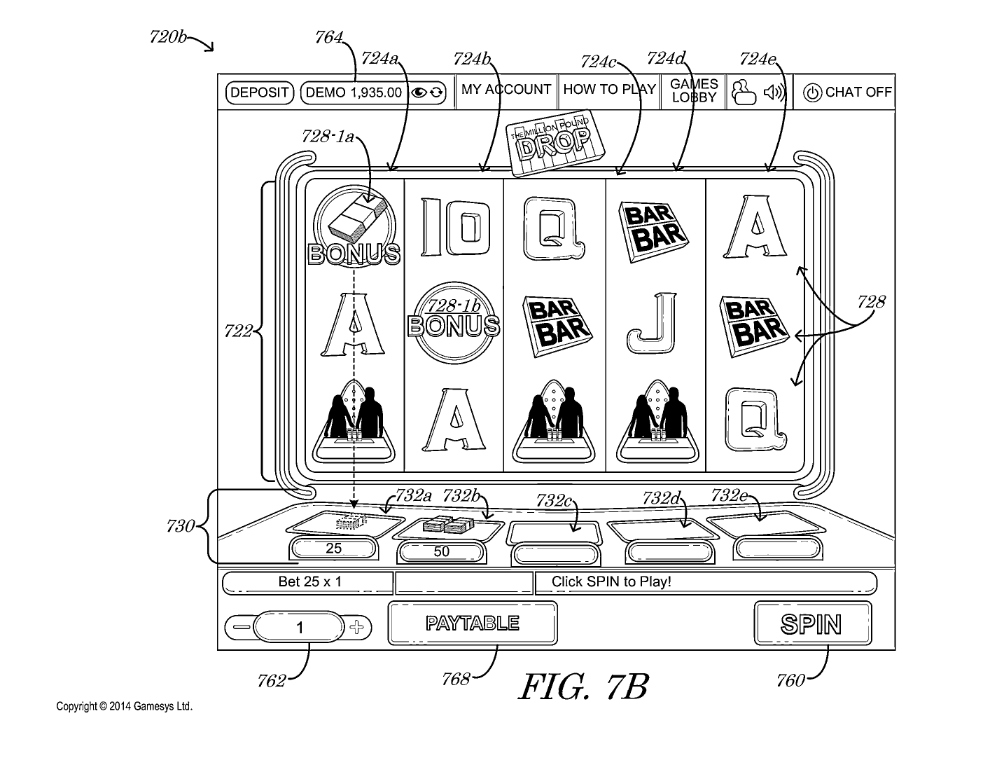

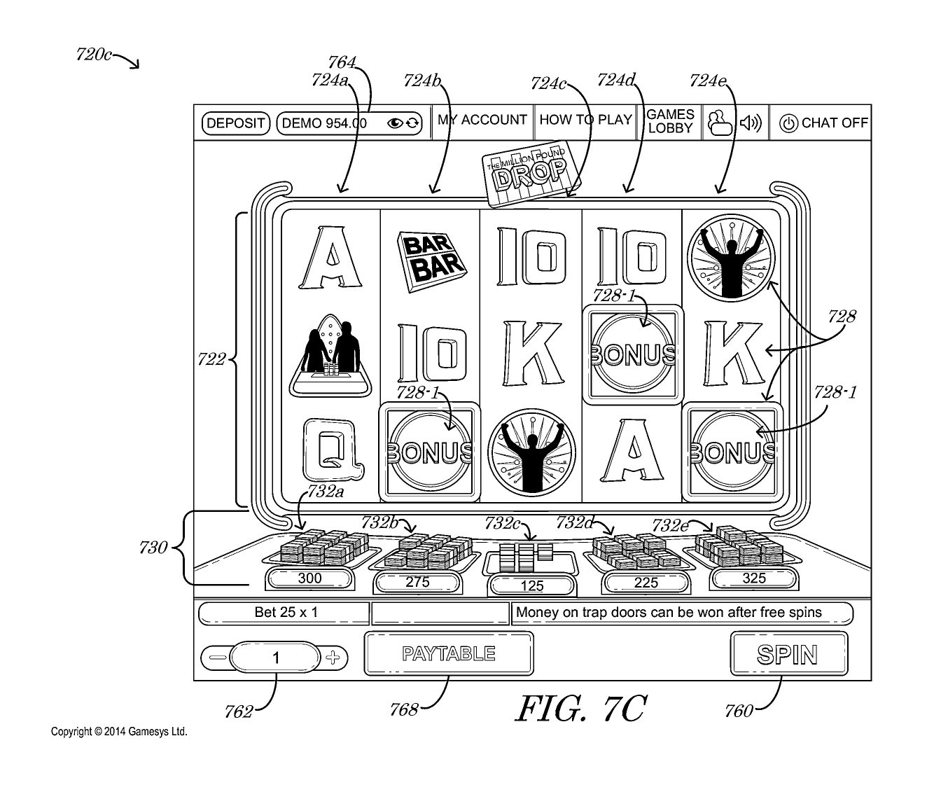

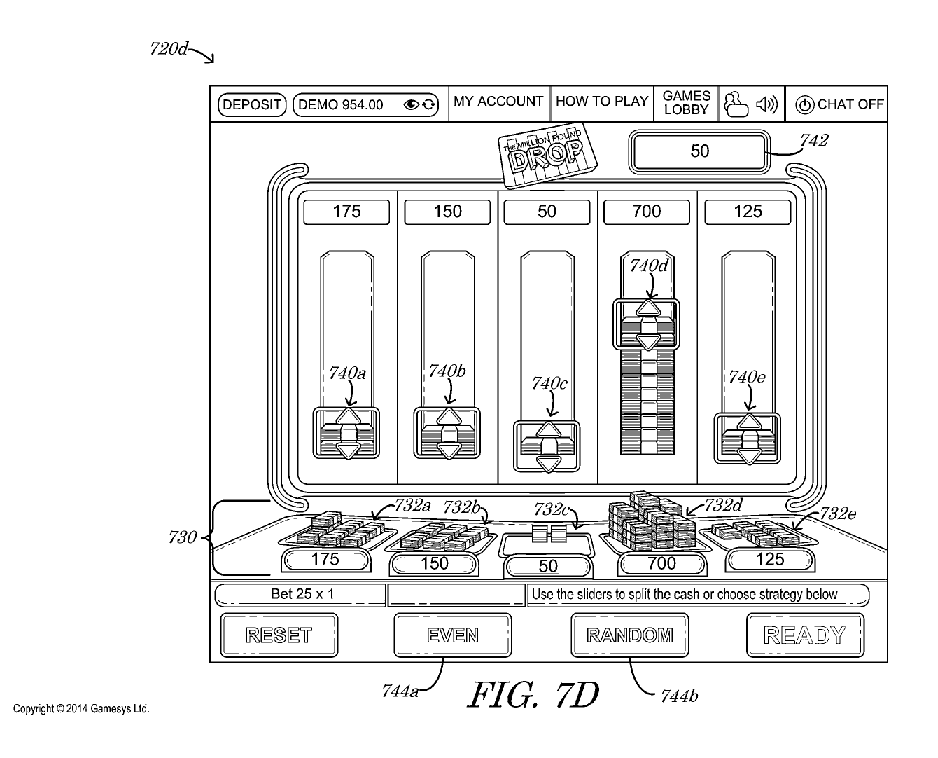

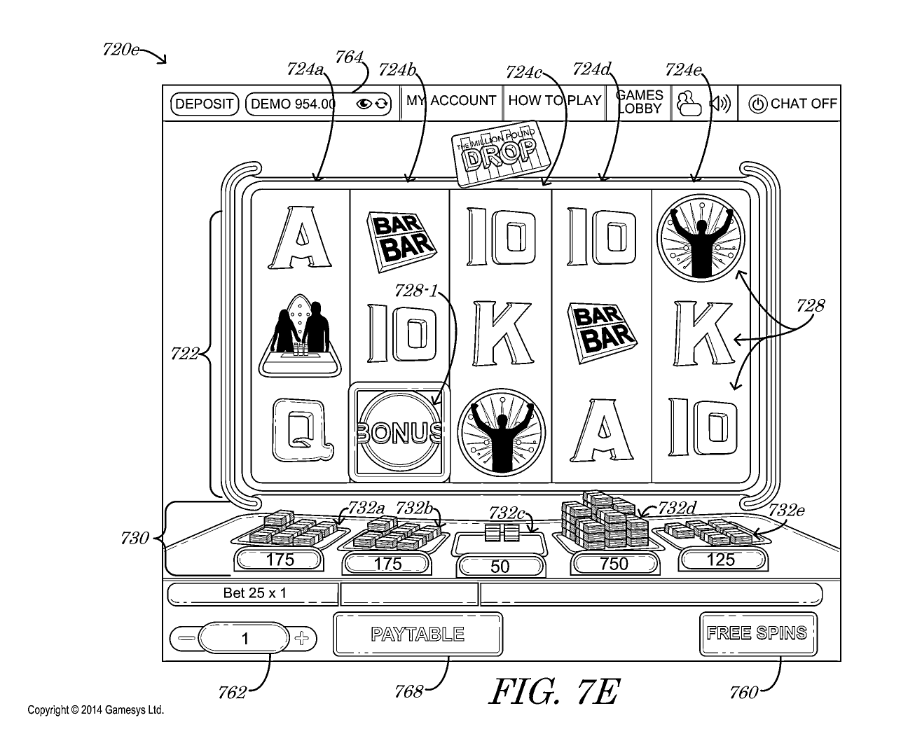

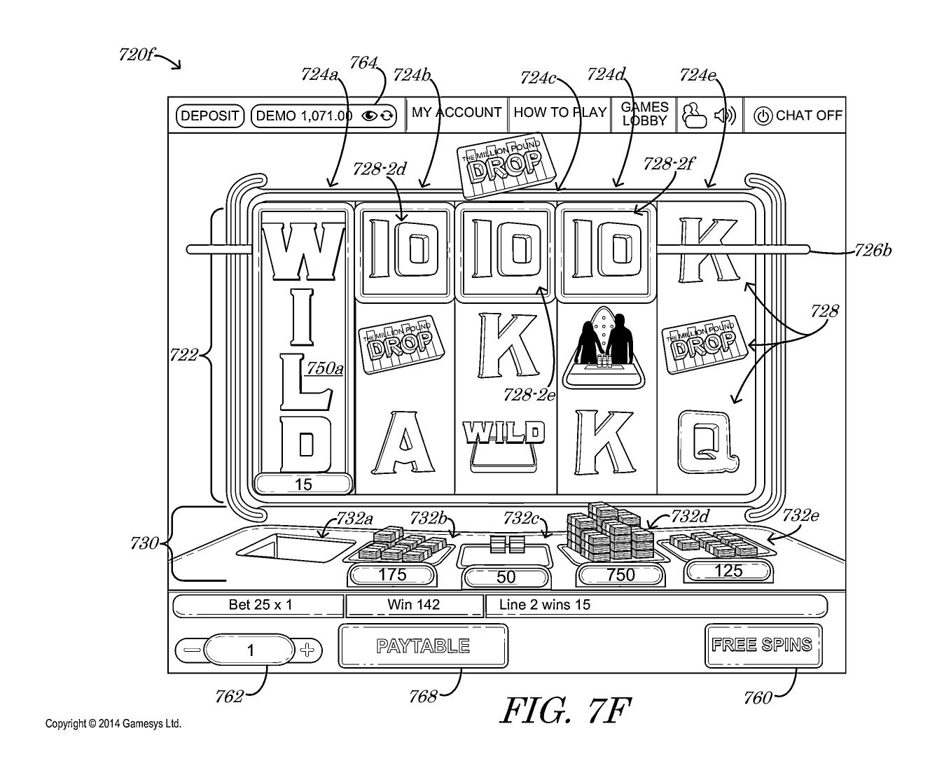

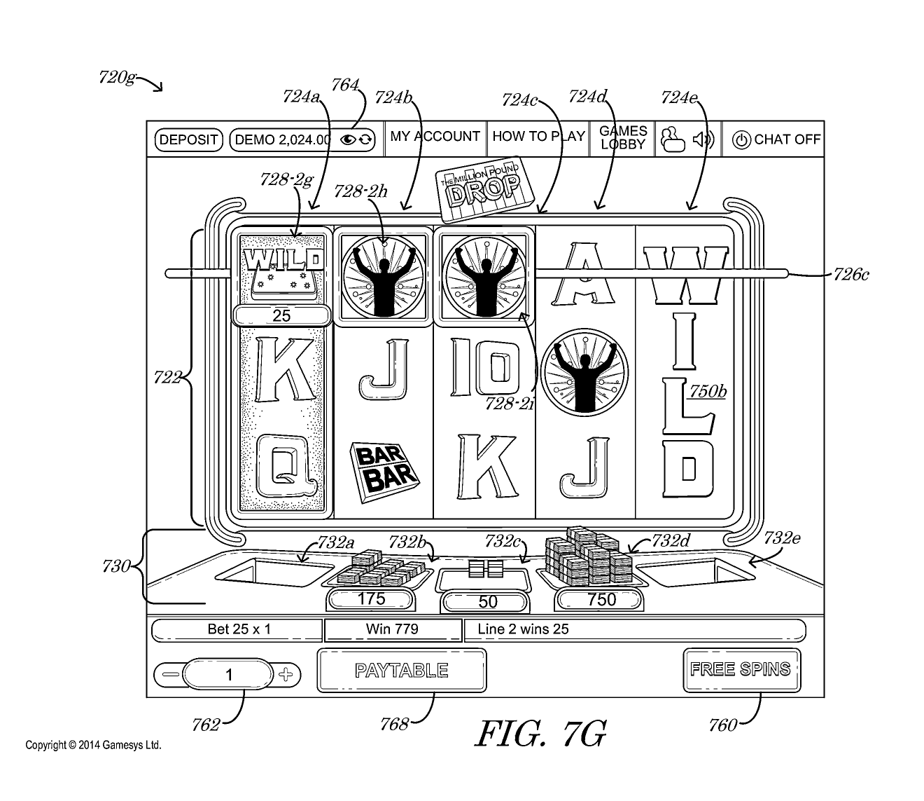

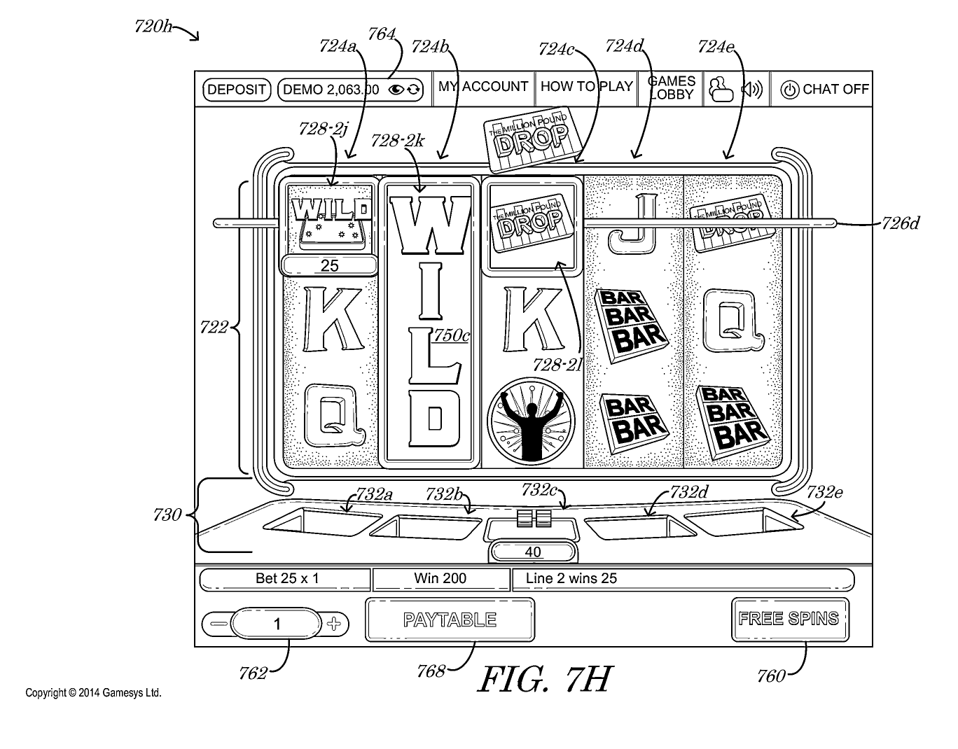

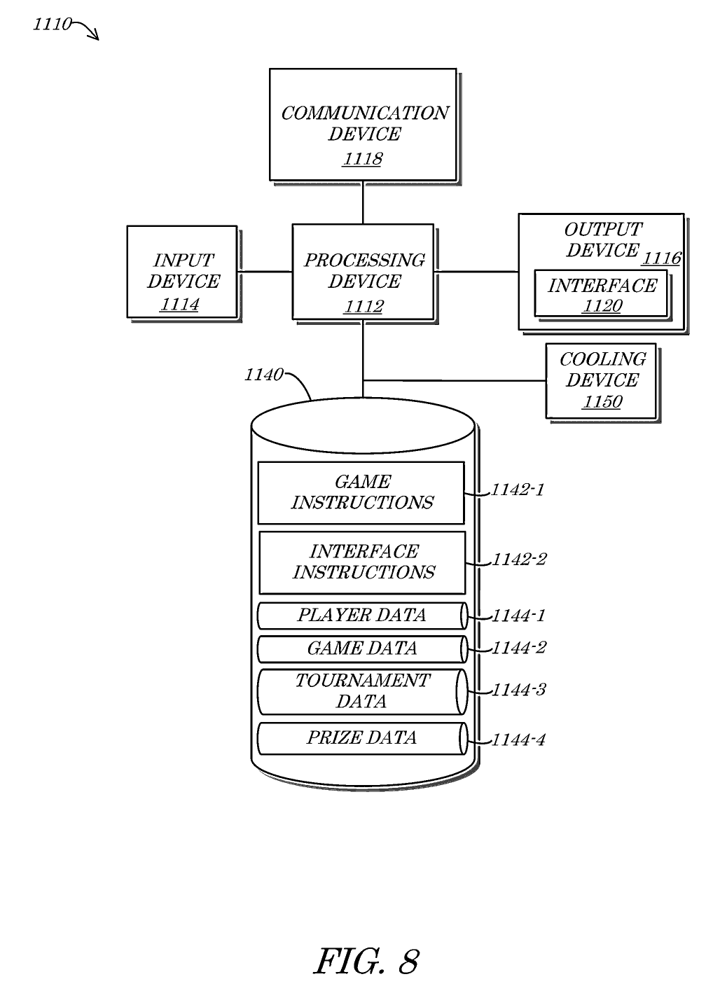

According to some embodiments, the game server 110 may comprise a device (and/or system) owned and/or operated by or on behalf of or for the benefit of a game provider and/or gaming entity (not explicitly shown). The game provider may utilize player and/or game information or instructions (e.g., stored by the database 140), in some embodiments, to host, manage, analyze, design, define, price, conduct, and/or otherwise provide (or cause to be provided) one or more games such as online multiplayer games, causal games, wagering games, slot-style games, and/or social network games. In some embodiments, the game provider (and/or a third-party; not explicitly shown) may provide an interface (not shown in FIG. 1; e.g., the interfaces 720a-h, 820 of FIG. 7A, FIG. 7B, FIG. 7C, FIG. 7D, FIG. 7E, FIG. 7F, FIG. 7G, FIG. 7H, and/or FIG. 8 herein) to and/or via the player devices 102a-n. The interface may be configured, according to some embodiments, to allow and/or facilitate electronic game play by one or more players. In some embodiments, the system 100 (and/or interface provided by the game server 110) may present game data (e.g., from the database 140) in such a manner that allows players to participate in one or more online and/or other games (singularly, in/with groups, and/or otherwise). According to some embodiments, the game server 110 may cause, implement, and/or output associated game symbols and/or bonus games, as described herein.

In some embodiments, the database 140 may comprise any type, configuration, and/or quantity of data storage devices that are or become known or practicable. The database 140 may, for example, comprise an array of optical and/or solid-state hard drives configured to store player and/or game data, and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the player devices 102a-n may comprise the database 140 or a portion thereof, for example, and/or the game server 110 may comprise the database 140 or a portion thereof.

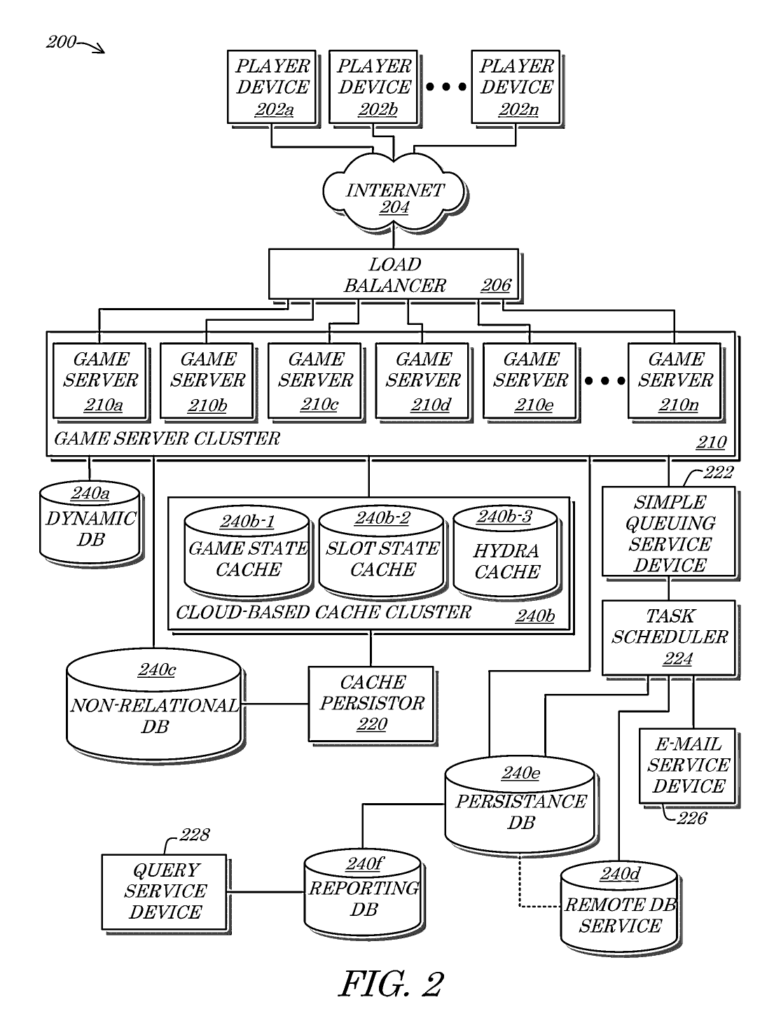

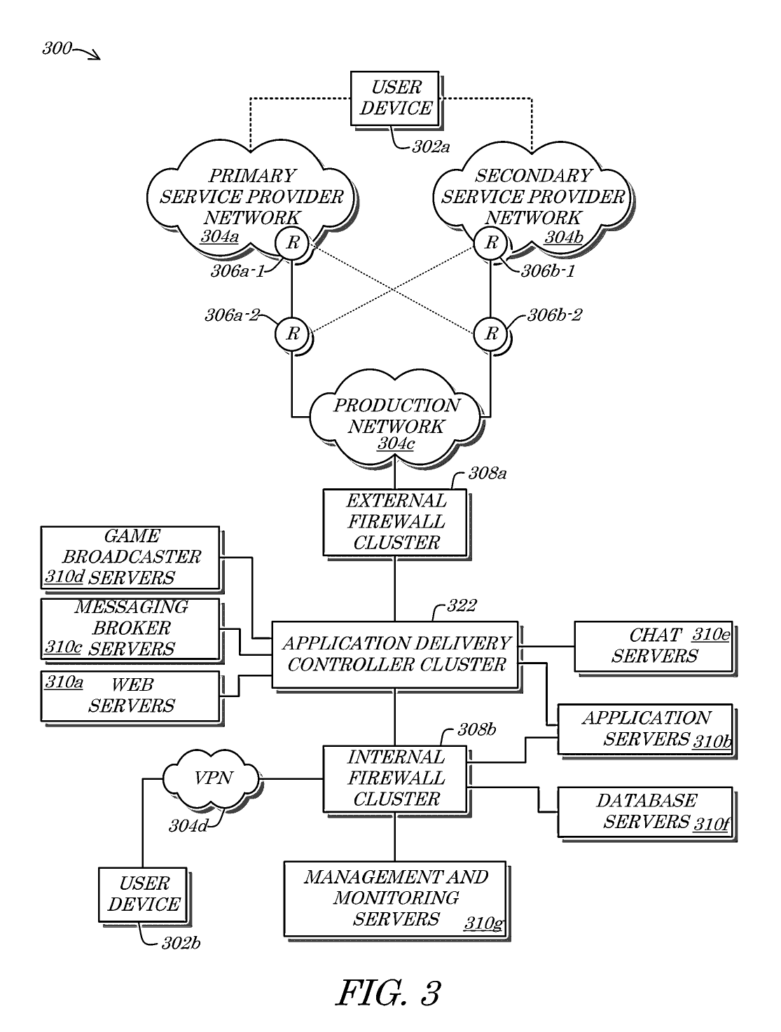

Referring now to FIG. 2, a block diagram of a system 200 according to some embodiments is shown. In some embodiments, the system 200 may comprise a gaming platform such as a platform via which social network, wagering, casual, multiplayer, slot-style, and/or online games may be played. In some embodiments, the system 200 may comprise a plurality of player devices 202a-n, the Internet 204, a load balancer 206, and/or a game server cluster 210. The game server cluster 210 may, in some embodiments, comprise a plurality of game servers 210a-n. In some embodiments, the system 200 may comprise a cache persistor 220, a Simple Queuing Service (SQS) device 222, a task scheduler 224, an e-mail service device 226, and/or a query service device 228. As depicted in FIG. 2, any or all of the various components 202a-n, 204, 206, 210a-n, 220, 222, 224, 226, 228 may be in communication with and/or coupled to one or more databases 240a-f. The system 200 may comprise, for example, a dynamic DataBase (DB) 240a, a cloud-based cache cluster 240b (e.g., comprising a game state cache 240b-1, a slot state cache 240b-2, and/or a “hydra” cache 240b-3), a non-relational DB 240c, a remote DB service 240d, a persistence DB 240e, and/or a reporting DB 240f.

According to some embodiments, any or all of the components 202a-n, 204, 206, 210a-n, 220, 222, 224, 226, 228, 240a-f of the system 200 may be similar in configuration and/or functionality to any similarly named and/or numbered components described herein. Fewer or more components 202a-n, 204, 206, 210a-n, 220, 222, 224, 226, 228, 240a-f (and/or portions thereof) and/or various configurations of the components 202a-n, 204, 206, 210a-n, 220, 222, 224, 226, 228, 240a-f may be included in the system 200 without deviating from the scope of embodiments described herein. While multiple instances of some components 202a-n, 210a-n, 240a-f are depicted and while single instances of other components 204, 206, 220, 222, 224, 226, 228 are depicted, for example, any component 202a-n, 204, 206, 210a-n, 220, 222, 224, 226, 228, 240a-f depicted in the system 200 may comprise a single device, a combination of devices and/or components 202a-n, 204, 206, 210a-n, 220, 222, 224, 226, 228, 240a-f, and/or a plurality of devices, as is or becomes desirable and/or practicable. Similarly, in some embodiments, one or more of the various components 202a-n, 204, 206, 210a-n, 220, 222, 224, 226, 228, 240a-f may not be needed and/or desired in the system 200. In some embodiments, the system 200 may be configured and/or utilized to implement and/or facilitate the method 600 of FIG. 6, or one or more portions thereof.

According to some embodiments, the player devices 202a-n may be utilized to access (e.g., via the Internet 204 and/or one or more other networks not explicitly shown) content provided by the game server cluster 210. The game server cluster 210 may, for example, provide, manage, host, and/or conduct various online and/or otherwise electronic games such as online bingo, slots, poker, and/or other games of chance, skill, and/or combinations thereof. In some embodiments, the various game servers 210a-n (virtual and/or physical) of the game server cluster 210 may be configured to provide, manage, host, and/or conduct individual instances and/or sessions of available game types. A first game server 210a, for example, may host a first particular session of an online bingo game (or tournament), a second game server 210c may host a second particular session of an online bingo game (or tournament), a third game server 210c may facilitate an online poker tournament (e.g., and a corresponding plurality of game sessions that comprise the tournament), and/or a fourth game server 210d may provide an online slots game (e.g., by hosting one or more slot game sessions).

In some embodiments, the player devices 202a-n may comprise various components (hardware, firmware, and/or software; not explicitly shown) that facilitate game play and/or interaction with the game server cluster 210. The player device 202a-n may, for example, comprise a gaming client such as a software application programmed in Adobe® Flash® and/or HTML 5 that is configured to send requests to, and receive responses from, one or more of the game servers 210a-n of the game server cluster 210. In some embodiments, such an application operating on and/or via the player devices 202a-n may be configured in Model-View-Controller (MVC) architecture with a communication manager layer responsible for managing the requests to/responses from the game server cluster 210. In some embodiments, one or more of the game servers 210a-n may also or alternatively be configured in a MVC architecture with a communication manager and/or communications management layer (not explicitly shown in FIG. 2). In some embodiments, communications between the player devices 202a-n and the game server cluster 210 may be conducted in accordance with the HyperText Transfer Protocol (HTTP) version 1.1 (HTTP/1.1) as published by the Internet Engineering Taskforce (IET) and the World Wide Web Consortium (W3C) in RFC 2616 (June 1999).

According to some embodiments, communications between the player devices 202a-n and the game server cluster 210 may be managed and/or facilitated by the load balancer 206. The load balancer 206 may, for example, route communications from player devices 202a-n to one or more of the specific game servers 210a-n depending upon various attributes and/or variables such as bandwidth availability (e.g., traffic management/volumetric load balancing), server load (e.g., processing load balancing), server functionality (e.g., contextual awareness/availability), and/or player-server history (e.g., session awareness/“stickiness”). In some embodiments, the load balancer 206 may comprise one or more devices and/or services provided by a third-party (not separately shown in FIG. 2). The load balancer 206 may, for example, comprise an Elastic Load Balancer (ELB) service provided by Amazon® Web Services, LLC of Seattle, Wash. According to some embodiments, such as in the case that the load balancer 206 comprises the ELB or a similar service, the load balancer 206 may manage, set, determine, define, and/or otherwise influence the number of game servers 210a-n within the game server cluster 210. In the case that traffic and/or requests from the player devices 202a-n only require the first and second game servers 210a-b, for example, all other game servers 210c-n may be taken off-line, may not be initiated and/or called, and/or may otherwise not be required and/or utilized in the system 200. As demand increases (and/or if performance, security, and/or other issues cause one or more of the first and second game servers 210a-b to experience detrimental issues), the load balancer 206 may call and/or bring online one or more of the other game servers 210c-n depicted in FIG. 2. In the case that each game server 210a-n comprises an instance of an Amazon® Elastic Compute Cloud (EC2) service, the load balancer 206 may add or remove instances as is or becomes practicable and/or desirable.

In some embodiments, the load balancer 206 and/or the Internet 204 may comprise one or more proxy servers and/or devices (not shown in FIG. 2) via which communications between the player devices 202a-n and the game server cluster 210 are conducted and/or routed. Such proxy servers and/or devices may comprise one or more regional game hosting centers, for example, which may be geographically dispersed and addressable by player devices 202a-n in a given geographic proximity. In some embodiments, the proxy servers and/or devices may be located in one or more geographic areas and/or jurisdictions while the game server cluster 210 (and/or certain game servers 210a-n and/or groups of game servers 210a-n thereof) is located in a separate and/or remote geographic area and/or jurisdiction.

According to some embodiments, for specific game types such as bingo, the game server cluster 210 may provide game results (such as a full set of drawn bingo numbers and/or bonus metrics) to a controller device (not separately shown in FIG. 2) that times the release of game result information to the player devices 202a-n such as by utilizing a broadcaster device (also not separately shown in FIG. 2) that transmits the time-released game results to the player devices 202a-n (e.g., in accordance with the Transmission Control Protocol (TCP) and Internet Protocol (IP) suite of communications protocols (TCP/IP), version 4, as defined by “Transmission Control Protocol” RFC 793 and/or “Internet Protocol” RFC 791, Defense Advance Research Projects Agency (DARPA), published by the Information Sciences Institute, University of Southern California, J. Postel, ed. (September 1981)).

In some embodiments, the game server cluster 210 (and/or one or more of the game servers 210a-n thereof) may be in communication with the dynamic DB 240a. According to some embodiments, the dynamic DB 240a may comprise a dynamically-scalable database service such as the DyanmoDB™ service provided by Amazon® Web Services, LLC. The dynamic DB 240a may, for example, store information specific to one or more certain game types (e.g., slots) provided by the game server cluster 210 such as to allow, permit, and/or facilitate reporting and/or analysis of such information.

According to some embodiments, the game server cluster 210 (and/or one or more of the game servers 210a-n thereof) may be in communication with the cloud-based cache cluster 240b. Game state information from the game server cluster 210 may be stored in the game state cache 240b-1, for example, slot state (e.g., slot-game specific state) data may be stored in the slot state cache 240b-2, and/or other game and/or player information (e.g., progressive data, referral data, player rankings, audit data) may be stored in the hydra cache 240b-3. In some embodiments, the cache persistor 220 may move and/or copy data stored in the cloud-based cache cluster 240b to the non-relational DB 240c. The non-relational DB 240c may, for example, comprise a SimpleDB™ service provided by Amazon® Wed Services, LLC. According to some embodiments, the game server cluster 210 may generally access the cloud-based cache cluster 240b as-needed to store and/or retrieve game-related information. The data stored in the cloud-based cache cluster 240b may generally comprise a subset of the newest or freshest data, while the cache persistior 220 may archive and/or store or move such data to the non-relational DB 240c as it ages and/or becomes less relevant (e.g., once a player logs-off, once a game session and/or tournament ends). The game server cluster 210 may, in accordance with some embodiments, have access to the non-relational DB 240c as-needed and/or desired. The game servers 210a-n may, for example, be initialized with data from the non-relational DB 240c and/or may store and/or retrieve low frequency and/or low priority data via the non-relational DB 240c.

In some embodiments, the SQS device 222 may queue and/or otherwise manage requests, messages, events, and/or other tasks or calls to and/or from the server cluster 210. The SQS device 222 may, for example, prioritize and/or route requests between the game server cluster 210 and the task scheduler 224. In some embodiments, the SQS device 222 may provide mini-game and/or tournament information to the server cluster 210. According to some embodiments, the task scheduler 224 may initiate communications with the SQS device 222, the e-mail service provider 226 (e.g., providing e-mail lists), the remote DB service 240d (e.g., providing inserts and/or updates), and/or the persistence DB 240e (e.g., providing and/or updating game, player, and/or other reporting data), e.g., in accordance with one or more schedules.

According to some embodiments, the persistence DB 240e may comprise a data store of live environment game and/or player data. The game server cluster 210 and/or the task scheduler 224 or SQS device 222 may, for example, store game and/or player data to the persistence DB 240e and/or may pull and/or retrieve data from the persistence DB 240e, as-needed and/or desired. The server cluster 210 may, according to some embodiments, provide and/or retrieve spin and/or other game event info and/or configuration information via the persistence DB 240e.

In some embodiments, the reporting DB 240f may be created and/or populated based on the persistence DB 240e. On a scheduled and/or other basis, for example, a data transformation and/or mapping program may be utilized to pull data from the live environment (e.g., the persistence DB 240e) into the reporting DB 240f. The query service 228 may then be utilized, for example, to query the reporting DB 240f, without taxing the live environment and/or production system directly accessible by the game server cluster 210.

Turning now to FIG. 3, a block diagram of a system 300 according to some embodiments is shown. In some embodiments, the system 300 may comprise and/or define a “front-end” architecture of a gaming platform such as a platform via which social network, causal, wagering, multiplayer, slot-style, and/or online games may be played. In some embodiments, the system 300 may comprise a plurality of user devices 302a-b, a plurality of networks 304a-b (e.g., a primary service provider network 304a, a secondary service provider network 304b, a production network 304c, and/or a VPN 304d), a plurality of routers 306a-b, a plurality of firewall devices 308a-b, a plurality of game servers 310a-g (e.g., web servers 310a, application servers 310b, messaging broker servers 310c, game broadcaster servers 310d, chat servers 310e, database servers 310f, and/or management and monitoring servers 310g), and/or an application delivery controller cluster 322.

According to some embodiments, any or all of the components 302a-b, 304a-b, 306a-b, 308a-b, 310a-g, 322 of the system 300 may be similar in configuration and/or functionality to any similarly named and/or numbered components described herein. Fewer or more components 302a-b, 304a-b, 306a-b, 308a-b, 310a-g, 322 (and/or portions thereof) and/or various configurations of the components 302a-b, 304a-b, 306a-b, 308a-b, 310a-g, 322 may be included in the system 300 without deviating from the scope of embodiments described herein. While multiple instances of some components 302a-b, 304a-b, 306a-b, 308a-b, 310a-g are depicted and while single instances of other components 322 are depicted, for example, any component 302a-b, 304a-b, 306a-b, 308a-b, 310a-g, 322 depicted in the system 300 may comprise a single device, a combination of devices and/or components 302a-b, 304a-b, 306a-b, 308a-b, 310a-g, 322, and/or a plurality of devices, as is or becomes desirable and/or practicable. Similarly, in some embodiments, one or more of the various components 302a-b, 304a-b, 306a-b, 308a-b, 310a-g, 322 may not be needed and/or desired in the system 300. In some embodiments, the system 300 may be configured and/or utilized to implement and/or facilitate the method 600 of FIG. 6, or one or more portions thereof.

In some embodiments, a first user device 304a may comprise an electronic device owned and/or operated by a player of an online game (not explicitly shown) and/or by an entity that otherwise accesses online game content and/or services externally (e.g., requiring external login and/or access credentials and/or procedures). The first user device 304a may, for example, be utilized to access content provided by and/or via the application delivery controller cluster 322. In some embodiments, the first user device 304a may interface with and/or connect to the production network 304c via the primary service provider network 304a and/or the secondary service provider network 304b. The primary service provider network 304a and the secondary service provider network 304b may, for example, load balance and/or provide redundant coverage for outage recovery by utilization of a first primary service provider network router 306a-1, a second primary service provider network router 306a-2, a first secondary service provider network router 306b-1, and/or a second secondary service provider network router 306b-2.

According to some embodiments, the application delivery controller cluster 322 may be insulated and/or protected from the production network 304c by an external firewall cluster 308a. The first user device 304a may, for example, be required to provide credentials to and/or otherwise access the application delivery controller cluster 322 via the external firewall cluster 308a.

In some embodiments, the application delivery controller cluster 322 may receive via and/or from the external firewall cluster 308a and/or the production network 304c, one or more requests, calls, transmissions, and/or commands from the first user device 304a. The first user device 304a may, for example, submit a call for an online gaming interface to the application delivery controller cluster 322. In some embodiments, the application delivery controller cluster 322 may comprise one or more hardware, software, and/or firmware devices and/or modules configured (e.g., specially-programmed) to route events and/or responses between the first user device 304a and one or more of the servers 310a-g. In the case that the first user device 304a is utilized to access an online gaming interface (not explicitly shown in FIG. 3; e.g., the interfaces 720a-h, 820 of FIG. 7A, FIG. 7B, FIG. 7C, FIG. 7D, FIG. 7E, FIG. 7F, FIG. 7G, FIG. 7H, and/or FIG. 8 herein) for example, one or more of the web servers 310a (e.g., that may provide graphical and/or rendering elements for an interface and/or other web services) and/or the application servers 310b (e.g., that may provide rule and/or logic-based programming routines, elements, and/or functions—e.g., game play engines) may be called and/or managed by the application delivery controller cluster 322.

In some embodiments, the messaging broker servers 310c may receive and/or retrieve messages from the first user device 304a (and/or from one or more of the other servers 310a-b, 310d-g) and perform one or more inter-application processes in relation thereto. The messaging broker servers 310c may, for example, route, transform, consolidate, aggregate, store, augment, and/or otherwise process one or more requests in connection with provision of online gaming services to the first user device 304a (e.g., facilitating a decoupling of services provided by various applications on and/or from the various servers 310a-b, 310d-g). According to some embodiments, the game broadcaster servers 310d may provide scheduled releases of information descriptive of an online game. The game broadcaster servers 310d may, for example, provide a broadcast feed of bingo numbers, slot and/or other random (and/or pseudo-random) number results that may be accessed by (and/or transmitted to) the first user device 304a (e.g., in connection with the play of an online bingo, slots, and/or other game for which broadcast information may be utilized). In some embodiments, the chat servers 310e may provide, manage, and/or facilitate communications between the first user device 304a (and/or first user thereof) and one or more other player/user devices (such as a second user device 302b and/or other player/user devices not shown in FIG. 3).

According to some embodiments, the second user device 304b may generally comprise an electronic device owned and/or operated by a user (not shown) closely affiliated with an entity that operates the system 300 (such entity also not shown; e.g., a game provider). An employee (e.g., programmer and/or Customer Service Representative (CSR)), contractor, and/or other agent of an online gaming company and/or other game provider may, for example, utilize the second user device 304b to interface with the privately-accessible VPN 304d. The VPN 304d may, for example, provide direct access to the application servers 310b, the database servers 310f, the management and monitoring servers 310g, and/or the application delivery controller cluster 322. In some embodiments (as depicted in FIG. 3), such access may be gated through and/or insulated or protected by an internal firewall cluster 308b. The second user device 304b may, for example, be required to provide credentials to and/or otherwise access the application delivery controller cluster 322 and/or servers 310a-g via the internal firewall cluster 308b.

In some embodiments, the database servers 310f may provide access to one or more databases and/or data stores (e.g., not shown in FIG. 3; for data storage and/or retrieval). In some embodiments, the management and monitoring servers 310g may provide services such as monitoring, reporting, troubleshooting, analysis, configuring, etc. to the second user device 304b. The second user device 304b may, for example, access the management and monitoring servers 310g and/or the database servers 310f to run reports descriptive of online gaming operations, game play, and/or game referral setup, management, and/or analysis. According to some embodiments, either or both of the user devices 304a-b in conjunction with one or more of the servers 310a-g and/or the application delivery controller cluster 322 may conduct (in whole or in part), facilitate, and/or otherwise be associated with execution of one or more stored procedures, applications, processes, and/or methods.

Utilization of the term “server” with respect to the servers 310a-g of the system 300 of FIG. 3 is meant solely to ease description of the configuration and/or functionality of the servers 310a-g. The term “server” is not intended to be limiting with respect to any particular hardware, software, firmware, and/or quantities thereof utilized to implement any or all of the servers 310a-g of the system 300. Similarly, while multiple types and/or instances of the severs 310a-g are depicted in FIG. 3, any or all of the servers 310a-g may be implemented in, on, and/or by one or multiple computer server and/or other electronic devices.

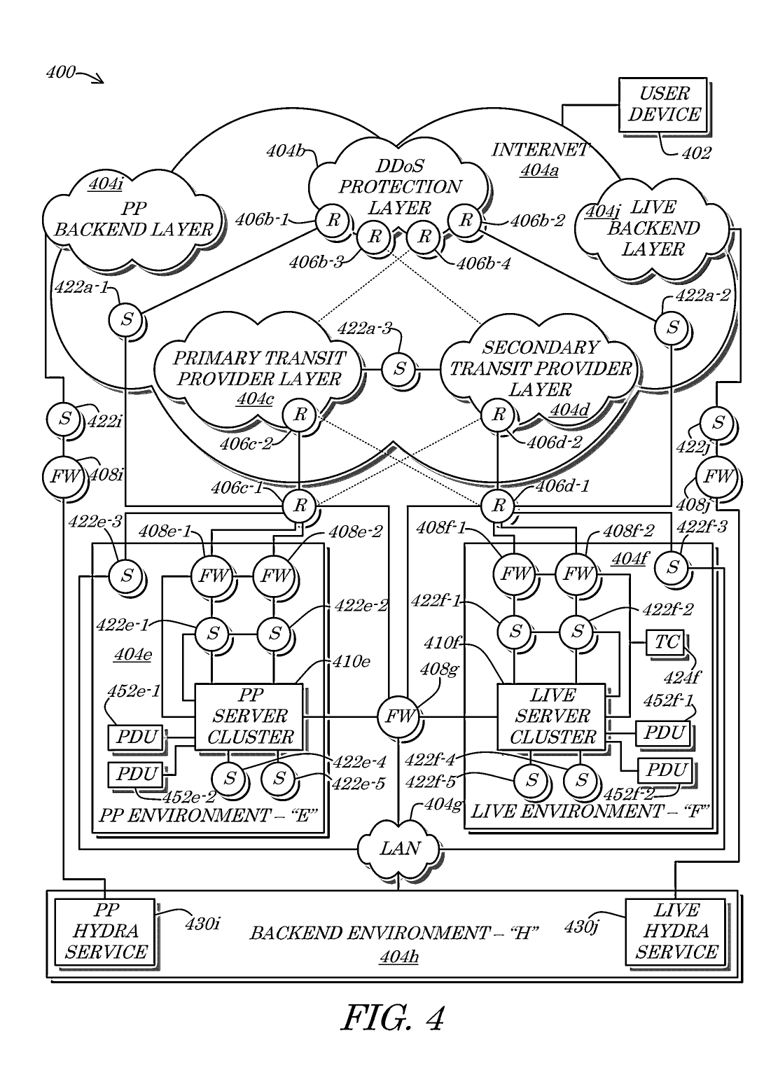

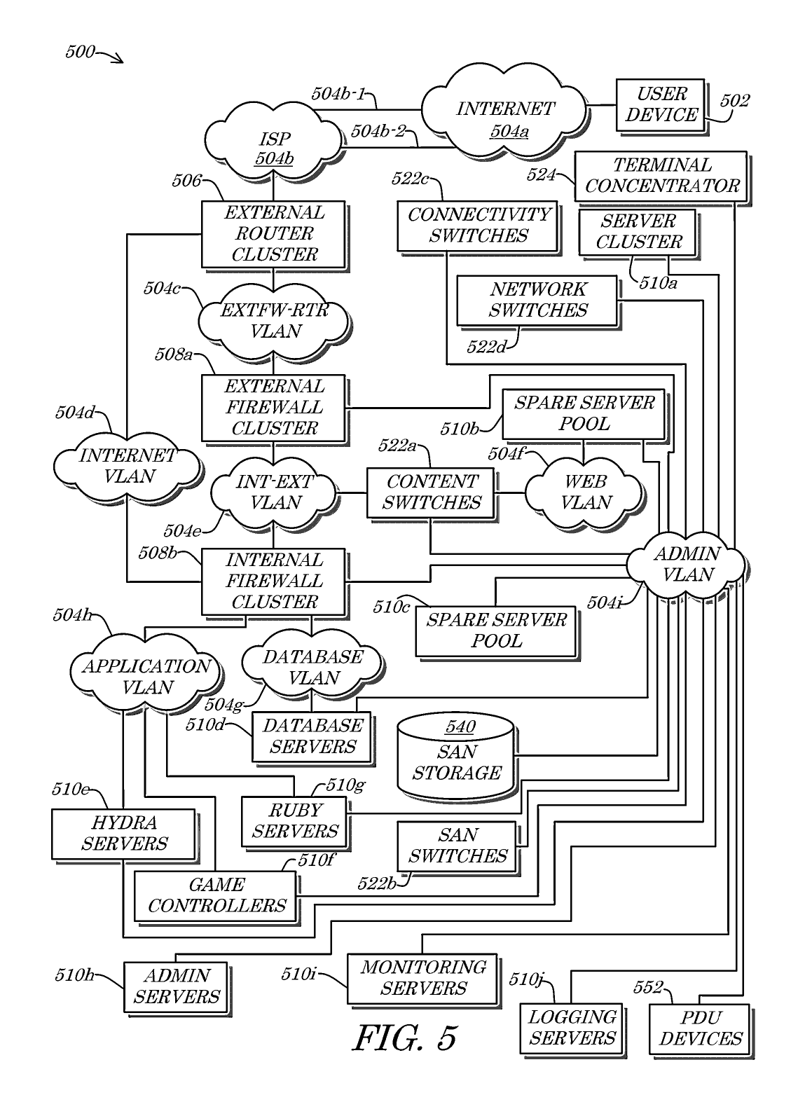

Referring now to FIG. 4, a block diagram of a system 400 according to some embodiments is shown. In some embodiments, the system 400 may comprise and/or define a “front-end” architecture of a gaming platform such as a platform via which social network, causal, wagering, multiplayer, slot-style, and/or online games may be played. The system 400 may be similar in configuration and/or functionality, for example, to the system 300 of FIG. 3 and/or one or more portions thereof. In some embodiments, the system 400 may comprise a user device 402, a plurality of networks (and/or environments and/or layers) 404a-j (e.g., the Internet 404a, a Distributed Denial-of-Service (DDoS) protection layer 404b, a primary transit provider layer 404c, a secondary transit provider layer 404d, a Pre-Production (PP) environment 404e, a live environment 404f, a LAN 404g, a backend environment 404h, a PP backend layer 404i, and/or a live backend layer 404j), a plurality of routers 406b-d, a plurality of firewall devices 408e-g, 408i-j, a plurality of servers 410e-f (e.g., a PP server cluster 410e and/or a live server cluster 410f), a plurality of switching devices 422a, 422e-f, 422i-j, a Terminal Concentrator (TC) 424f, a plurality of “hydra” services 430i-j (e.g., a PP hydra service 430i and/or a live hydra service 430j), and/or a plurality of Power Distribution Unit (PDU) devices 452e-f.

According to some embodiments, any or all of the components 402, 404a-j, 406b-d, 408e-g, 408i-j, 410e-f, 422a, 422e-f, 422i-j, 424f, 430i-j, 452e-f of the system 400 may be similar in configuration and/or functionality to any similarly named and/or numbered components described herein. Fewer or more components 402, 404a-j, 406b-d, 408e-g, 408i-j, 410e-f, 422a, 422e-f, 422i-j, 424f, 430i-j, 452e-f (and/or portions thereof) and/or various configurations of the components 402, 404a-j, 406b-d, 408e-g, 408i-j, 410e-f, 422a, 422e-f, 422i-j, 424f, 430i-j, 452e-f may be included in the system 400 without deviating from the scope of embodiments described herein. While multiple instances of some components 404a-j, 406b-d, 408e-g, 408i-j, 410e-f, 422a, 422e-f, 422i-j, 430i-j, 452e-f are depicted and while single instances of other components 402, 424f are depicted, for example, any component 402, 404a-j, 406b-d, 408e-g, 408i-j, 410e-f, 422a, 422e-f, 422i-j, 424f, 430i-j, 452e-f depicted in the system 400 may comprise a single device, a combination of devices and/or components 402, 404a-j, 406b-d, 408e-g, 408i-j, 410e-f, 422a, 422e-f, 422i-j, 424f, 430i-j, 452e-f, and/or a plurality of devices, as is or becomes desirable and/or practicable. Similarly, in some embodiments, one or more of the various components 402, 404a-j, 406b-d, 408e-g, 408i-j, 410e-f, 422a, 422e-f, 422i-j, 424f, 430i-j, 452e-f may not be needed and/or desired in the system 400. In some embodiments, the system 400 may be configured and/or utilized to implement and/or facilitate the method 600 of FIG. 6, or one or more portions thereof.

In some embodiments, the user device 402 may be utilized to access one or more of the PP environment 404e, the live environment 404f, and/or the backend environment 404h via the Internet 404a. In some embodiments, the user device 402 may be utilized to access the backend environment 404h and/or the PP hydra service 430i via the PP backend layer 404i. A PP backend switch device 422i and/or a PP backend firewall device 408i may, for example, gate and/or control access to the backend environment 404h and/or the PP hydra service 430i, via the PP backend layer 404i. In some embodiments, the user device 402 may be utilized to access the backend environment 404h and/or the live hydra service 430j via the live backend layer 404j. A live backend switch device 422j and/or a live backend firewall device 408j may, for example, gate and/or control access to the backend environment 404h and/or the live hydra service 430j, via the live backend layer 404j.

According to some embodiments, any communications (e.g., requests, calls, and/or messages) from the user device 402 may be passed through the DDoS protection layer 404b. The DDoS protection layer 404b may, for example, monitor and/or facilitate protection against various forms of cyber attacks including, but not limited to, DDoS attacks. In some embodiments, the DDoS protection layer 404b may comprise and/or be in communication with a plurality of DDoS router devices 406b-1, 406b-2, 406b-3, 406b-4 that may be utilized to route and/or direct incoming communications (e.g., from the user device 402) to appropriate portions of the system 400.

In some embodiments, the DDoS protection layer 404b and/or a first DDoS router device 406b-1 may route communications from the user device 402 through and/or via a first switch device 422a-1 and/or to, through, and/or via a first primary transit provider router device 406c-1. In some embodiments, the first switch device 422a-1 may comprise a device utilized for security switching such as may implement communications in accordance with the Generic Routing Encapsulation (GRE) communications tunneling protocol described in RFC 2784 “Generic Routing Encapsulation (GRE)” published by the Network Working Group (NWG) in March, 2000. The first primary transit provider router device 406c-1 may, for example, provide access to the PP environment 404e and/or the PP server cluster 410e thereof, such as via one or more PP firewall devices 408e-1, 408e-2 and/or one or more PP switch devices 422e-1, 422e-2. According to some embodiments, the PP switch devices 422e-1, 422e-2 may comprise content switching devices that process and route data (e.g., in the data link layer) based on data content. In some embodiments, the first primary transit provider router device 406c-1 may direct communications to, through, and/or via a PP LAN switch device 422e-3 that provides and/or facilitates access to the LAN 404g. The LAN 404g may, for example, provide private access to and/or between the PP environment 404e, the live environment 404f, and/or the backend environment 404h. In some embodiments, the first primary transit provider router device 406c-1 and/or the PP LAN switch device 422e-3 may direct communications to, through, and/or via a LAN firewall device 408g that provides direct access to either or both of the PP server cluster 410e and the live server cluster 410f.

According to some embodiments, the DDoS protection layer 404b and/or a second DDoS router device 406b-2 may route communications from the user device 402 through and/or via a second switch device 422a-2 and/or to, through, and/or via a first secondary transit provider router device 406d-1. In some embodiments, the second switch device 422a-2 may comprise a device utilized for security switching such as may implement communications in accordance with the GRE communications tunneling protocol described in RFC 2784 “Generic Routing Encapsulation (GRE)” published by the Network Working Group (NWG) in March, 2000. The first secondary transit provider router device 406d-1 may, for example, provide access to the live environment 404f and/or the live server cluster 410f thereof, such as via one or more live firewall devices 408f-1, 408f-2 and/or one or more live switch devices 422f-1, 422f-2. According to some embodiments, the live switch devices 422f-1, 422f-2 may comprise content switching devices that process and route data (e.g., in the data link layer) based on data content. In some embodiments, the first secondary transit provider router device 406d-1 may direct communications to, through, and/or via a live LAN switch device 422f-3 that provides and/or facilitates access to the LAN 404g. In some embodiments, the first secondary transit provider router device 406d-1 and/or the live LAN switch device 422f-3 may direct communications to, through, and/or via the LAN firewall device 408g that provides direct access to either or both of the PP server cluster 410e and the live server cluster 410f.

In some embodiments, the DDoS protection layer 404b and/or one or more of a third DDoS router device 406b-3 and/or a fourth DDoS router device 406b-4 may route communications from the user device 402 through and/or via one or more of the primary transit provider layer 404c and/or the secondary transit provider layer 404d. In some embodiments, a transit provider switch device 422a-3 may direct, swap, route, and/or manage communications between the primary transit provider layer 404c and the secondary transit provider layer 404d. According to some embodiments, the transit provider switch device 422a-3 may comprise a switching device that operates in accordance with an Exterior Border Gateway Protocol (EBGP)—e.g., the transit provider switch device 422a-3 may comprise one or more edge or border routers. In some embodiments, the first primary transit provider router device 406c-1, the first secondary transit provider router device 406d-1, a second primary transit provider router device 406c-2, and/or a second secondary transit provider router device 406d-2 may be utilized to route and/or direct communications between (i) the primary transit provider layer 404c and/or the secondary transit provider layer 404d and (ii) the PP environment 404e and/or the live environment 404f.

According to some embodiments, the PP server cluster 410e and/or the PP environment 404e may comprise various hardware, software, and/or firmware that permits a user (e.g., of the user device 402) to program, edit, manage, and/or otherwise interface with PP game elements and/or interfaces (e.g., for development and/or testing purposes). In some embodiments, the PDU devices 452e-1, 452e-2 may generally provide power distribution, supply, management, backup, and/or conditioning services (e.g., to the PP server cluster 410e) as is or becomes desired. According to some embodiments, additional switch devices 422e-4, 422e-5 may be utilized to distribute, balance, manage and/or control communications to, from, and/or within the PP server cluster 410e.

In some embodiments, the live server cluster 410f and/or the live environment 404f may comprise various hardware, software, and/or firmware that permits a user (e.g., of the user device 402) to program, edit, manage, and/or otherwise interface with live game elements and/or interfaces (e.g., for troubleshooting, corrective, and/or live environment management purposes; e.g., the interfaces 720a-h, 820 of FIG. 7A, FIG. 7B, FIG. 7C, FIG. 7D, FIG. 7E, FIG. 7F, FIG. 7G, FIG. 7H, and/or FIG. 8 herein). In some embodiments, the PDU devices 452f-1, 452f-2 may generally provide power distribution, supply, management, backup, and/or conditioning services (e.g., to the live server cluster 410f) as is or becomes desired. According to some embodiments, additional switch devices 422f-4, 422f-5 may be utilized to distribute, balance, manage and/or control communications to, from, and/or within the live server cluster 410f. In some embodiments, the TC device 424f may be utilized to manage communications from a variety of data sources such as by providing communication capability between various communications channels (not separately depicted in FIG. 4).

Turning to FIG. 5, a block diagram of a system 500 according to some embodiments is shown. In some embodiments, the system 500 may comprise and/or define a “back-end” architecture of a gaming platform such as a platform via which social network, casual, wagering, multiplayer, slot-style, and/or online games may be played. The system 500 may be utilized in conjunction with the systems 300, 400 if FIG. 3 and/or FIG. 4 herein, for example, and/or may be similar in configuration and/or functionality to the backend environment 404h of the system 400 of FIG. 4. In some embodiments, the system 500 may comprise a user device 502, a plurality of networks (and/or environments and/or layers) 504a-i (e.g., the Internet 504a, an ISP 504b, an External Firewall-Router (EXTFW-RTR) Virtual LAN (VLAN) 504c, an Internet VLAN 504d, an Internal-External (INT-EXT) VLAN 504e, a web VLAN 504f, a database VLAN 504g, an application VLAN 504h, and/or an administrator VLAN 504i), an external router cluster 506, a plurality of firewall clusters 508a-b (e.g., an external firewall cluster 508a and/or an internal firewall cluster 508b), a plurality of servers 510a-j (e.g., a server cluster 510a, a first spare server pool 510b, a second spare server pool 510c, database servers 510d, “hydra” servers 510e, game controllers 510f, ruby servers 510g, admin servers 510h, monitoring servers 510i, and/or logging servers 510j), a plurality of switches 522a-d (e.g., content switches 522a, Storage Area Network (SAN) switches 522b, connectivity switches 522c, and/or network switches 522d), a TC device 524, a SAN storage device 540, and/or one or more PDU devices 552.

According to some embodiments, any or all of the components 502, 504a-l, 506, 508a-b, 510a-j, 522a-d, 524, 540, 552 of the system 500 may be similar in configuration and/or functionality to any similarly named and/or numbered components described herein. Fewer or more components 502, 504a-l, 506, 508a-b, 510a-j, 522a-d, 524, 540, 552 (and/or portions thereof) and/or various configurations of the components 502, 504a-l, 506, 508a-b, 510a-j, 522a-d, 524, 540, 552 may be included in the system 500 without deviating from the scope of embodiments described herein. While multiple instances of some components 504a-l, 508a-b, 510a-j, 522a-d are depicted and while single instances of other components 502, 506, 524, 540, 552 are depicted, for example, any component 502, 504a-l, 506, 508a-b, 510a-j, 522a-d, 524, 540, 552 depicted in the system 500 may comprise a single device, a combination of devices and/or components 502, 504a-l, 506, 508a-b, 510a-j, 522a-d, 524, 540, 552, and/or a plurality of devices, as is or becomes desirable and/or practicable. Similarly, in some embodiments, one or more of the various components 502, 504a-l, 506, 508a-b, 510a-j, 522a-d, 524, 540, 552 may not be needed and/or desired in the system 500. In some embodiments, the system 500 may be configured and/or utilized to implement and/or facilitate the method 600 of FIG. 6, or one or more portions thereof.

In some embodiments, the user device 502 may be utilized to access and/or interface with one or more of the servers 510a-j via the Internet 504a. In some embodiments, the Internet 502a may be linked to the ISP 504b via multiple (e.g., redundant) connectivity paths 504b-1, 504b-2 (e.g., for load balancing, security, and/or failure recovery). According to some embodiments, the ISP 504b may be in communication with (and/or comprise) the external router cluster 506. The external router cluster 506 may route certain requests, calls, and/or transmissions (and/or users—e.g., based on credentials and/or other information) through the EXTFW-RTR VLAN 504c and/or through the external firewall cluster 508a, for example, and/or may route certain requests, calls, and/or transmissions (and/or users—e.g., based on credentials and/or other information) through the Internet VLAN 504d and/or through the internal firewall cluster 508b.

In the case that a user (not shown) of the user device 502 comprises an online game player, consumer, and/or other member of the public, for example, the external router cluster 506 may direct communications through the EXTFW-RTR VLAN 504c and/or through the external firewall cluster 508a. In the case that the user of the user device 502 comprises a programmer, tester, employee, and/or other agent of an entity that operates the system 500 (e.g., a game provider), for example, the external router cluster 506 may direct communications through the Internet VLAN 504d and/or through the internal firewall cluster 508b. In some embodiments, access via either or both of the external firewall cluster 508a and/or the internal firewall cluster 508b may permit the user device 502 to communicate via the INT-EXT VLAN 504e. The INT-EXT VLAN 504e may, for example, provide access to the content switches 522a which may, in some embodiments, serve content from any or all of the servers 510a-j to the user device 502, as is or becomes appropriate or desired. In some embodiments, the content switches 522a may communicate with the first spare server pool 510b via the web LAN 504f.

According to some embodiments, private and/or other specialized access to the system 500 via the internal firewall cluster 508b may permit the user device 502 to communicate via one or more of the database VLAN 504g, the application VLAN 504h, and/or the admin VLAN 504i. The database VLAN 504g may be utilized, for example, to access and/or communicate with the database servers 510d. In some embodiments, the application VLAN 504h may be utilized to access and/or communicate with any or all of the hydra servers 510e, the game controllers 510f, and/or the ruby servers 510g.

The admin VLAN 504i may allow, promote, conduct, facilitate, and/or manage a wide variety of communications within the system 500. The admin VLAN 504i may, for example, communicatively connect and/or couple any or all of the firewalls 508a-b, the servers 510a-j, the switches 522a-d, the TC device 524, the SAN storage 540, and/or the PDU devices 552. The user device 502 may be utilized, in conjunction with the admin servers 510h and/or via the admin VLAN 504i for example, to define, edit, adjust, manage, and/or otherwise access settings (and/or data) of the firewalls 508a-b, any or all of the switches 522a-d, the TC device 524, and/or the PDU devices 552. In some embodiments, the user device 502 (and/or the admin servers 510h) may be utilized to manage and/or access content, rules, settings, and/or performance characteristics or preferences for any or all of the servers 510a-j.

In some embodiments, the server cluster 510a may comprise one or more servers and/or other electronic controller devices (e.g., blade servers) configured to provide online gaming data (e.g., interfaces such as the interfaces 720a-h, 820 of FIG. 7A, FIG. 7B, FIG. 7C, FIG. 7D, FIG. 7E, FIG. 7F, FIG. 7G, FIG. 7H, and/or FIG. 8 herein, and/or outcomes or results) to the user device 502. According to some embodiments, the first spare server pool 510b and/or the second spare server pool 510c may comprise one or more server and/or other electronic controller devices configured to supplement and/or replace the server cluster 510a as needed and/or desired (e.g., to manage load and/or error recovery situations). In some embodiments, the database servers 510c may provide and/or manage access to stored data such as data stored in and/or by the SAN storage device 540. In some embodiments, the hydra servers 510e and/or the game controllers 510f may provide online game information such as interfaces, outcomes, results, graphics, sounds, and/or other media to the user device 502 (e.g., via the application VLAN 504h). In some embodiments, the ruby servers 510g may comprise one or more processing devices configured to provide access to one or more programming languages (e.g., “Ruby”) and/or Application Programming Interface (API) mechanisms via which the servers 510a-j and/or other portions of the system 500 may be configured to operate (e.g., in accordance with specially and/or pre-programmed instructions written in the programming language and/or developed by the API provided by the ruby servers 510g). According to some embodiments, the admin servers 510h, the monitoring servers 510i, and/or the logging servers 510j may be utilized and/or configured to provide administrative, parameter and/or metric monitoring and/or reporting, and/or data logging and/or audit services, respectively.

Turning now to FIG. 6, a flow diagram of a method 600 according to some embodiments is shown. In some embodiments, the method 600 may be implemented, facilitated, and/or performed by or otherwise associated with the systems 100, 200, 300, 400, 500 of FIG. 1, FIG. 2, FIG. 3, FIG. 4, and/or FIG. 5 herein (and/or portions thereof, such as the user devices 102a-n, 202a-n, 302a-b, 402, 502 and/or the servers 110, 210a-n, 310a-g, 410e-f, 510a j).

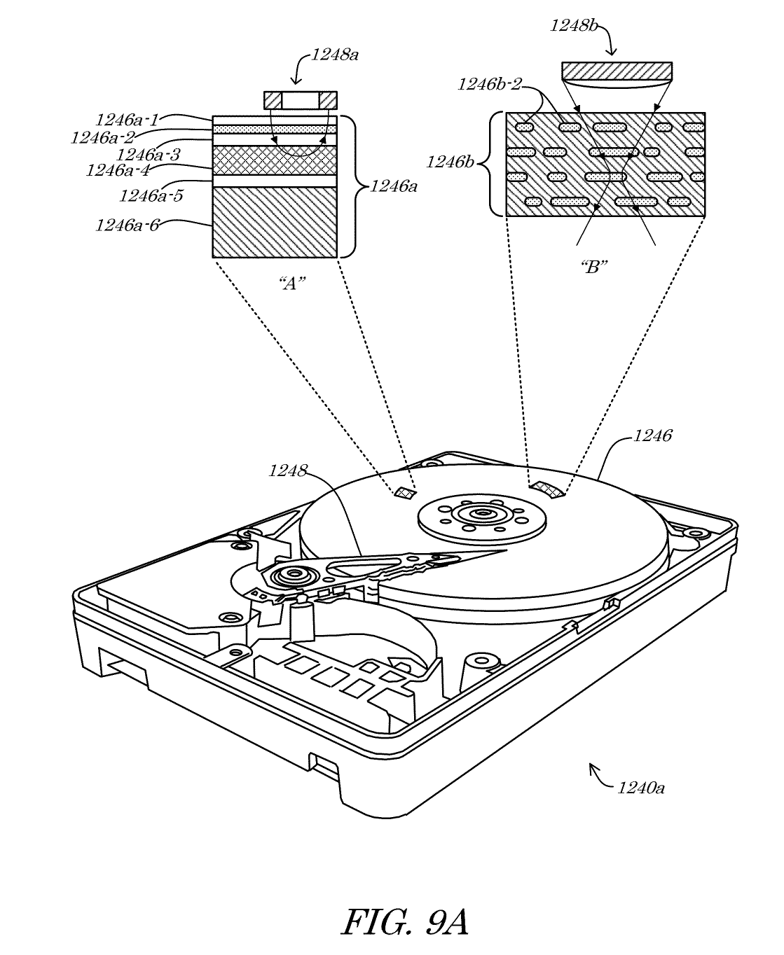

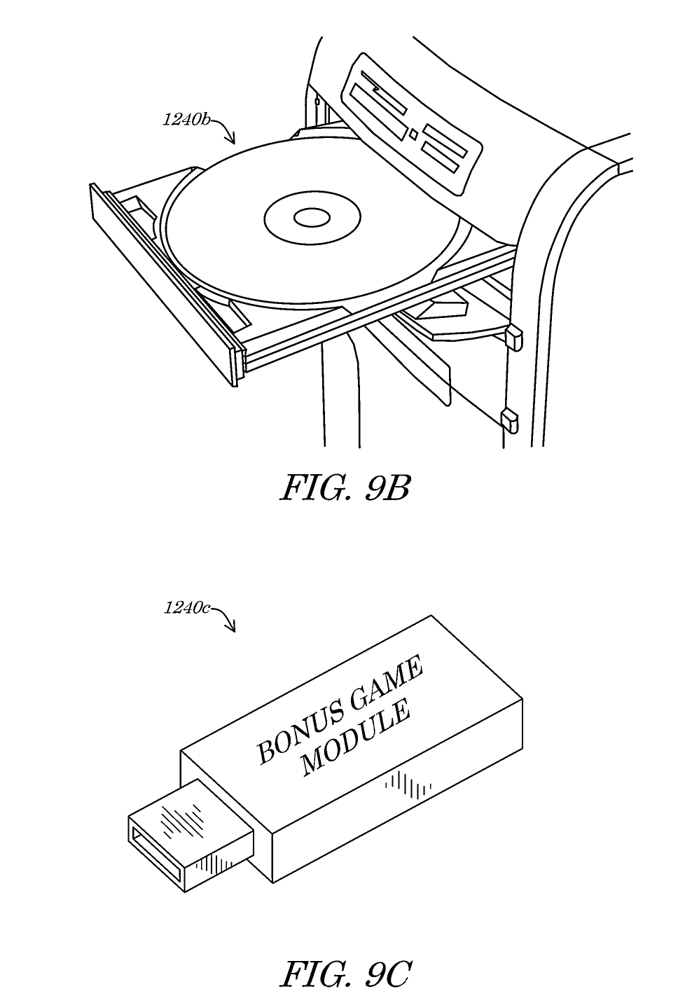

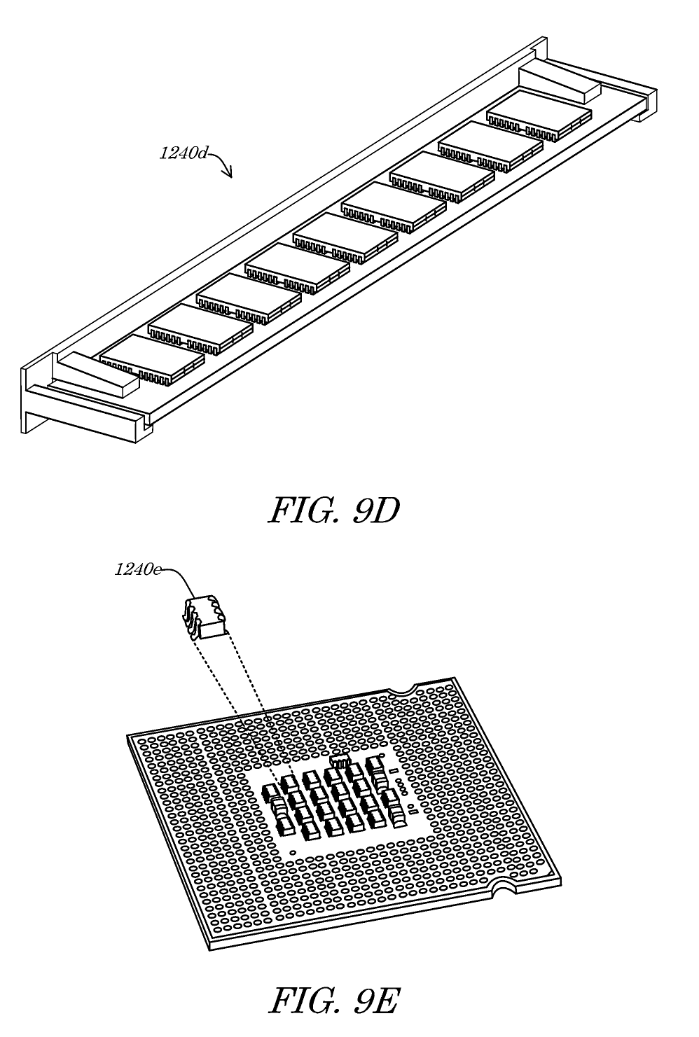

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 140, 240a-f, 540, 840, 940a-e of FIG. 1, FIG. 2, FIG. 5, FIG. 8, FIG. 9A, FIG. 9B, FIG. 9C, FIG. 9D, and/or FIG. 9E herein) may store thereon instructions that when executed by a machine (such as a computerized processor) result in performance according to any one or more of the embodiments described herein.

According to some embodiments, the method 600 may comprise providing (e.g., by a processing device) a slot-style gaming interface, at 602. A user device may, for example, output a gaming interface such as the interfaces 720a-h, 820 of FIG. 7A, FIG. 7B, FIG. 7C, FIG. 7D, FIG. 7E, FIG. 7F, FIG. 7G, FIG. 7H, and/or FIG. 8 herein. In some embodiments, an outputting of such a gaming interface by the user device may be caused by a server and/or other network device (e.g., processing devices that provide or cause a providing) such as by receiving an interface output command transmitted there from. In some embodiments, the providing of the interface may comprise providing appropriate login, network navigation, and/or credential information to a user and/or user device. According to some embodiments, the providing of the interface may comprise a providing (e.g., downloading) of software, hardware, and/or firmware that enables and/or initiates instructions that cause a generation and/or outputting of the gaming interface. A user of a mobile device may, for example, visit a website (e.g., a gaming company's website and/or a mobile device application online marketplace) and download a plugin and/or application that allows the user's device to display the gaming interface.

In some embodiments, the slot-style gaming interface may comprise one or more virtual, physical, and/or other slot-style reels. Such slot-style reels may, for example, comprise and/or define a plurality of symbol positions that define a matrix of slot symbol positions. In some embodiments, each particular reel may be associated with (e.g., tied and/or related to) and/or connected with one or more bonus areas and/or elements (e.g., a plurality of bonus value accumulation areas). According to some embodiments, bonus events (e.g., an occurrence of a bonus symbol) occurring on a particular slot reel may cause and/or trigger an action with respect to the one or more bonus areas and/or elements tied to that particular reel. In a five (5)-reel slot-style game, for example, an occurrence of a bonus triggering event may cause a value associated with a third one of the reels to become associated with (e.g., populated and/or assigned to) a third one of the one or more bonus areas and/or elements tied to the third reel.

In some embodiments, the method 600 may comprise determining (e.g., by the processing device) an outcome of the slot-style game, at 604. The slot-style game may, for example, comprise a wagering, casual, social network, multiplayer, and/or online game such as a “trap door”-themed game. The slot-style game outcome may accordingly be random, pseudo-random, skill, and/or otherwise based, including combinations thereof. In some embodiments, the outcome may be based on and/or defined by one or more random (or pseudo-random) numbers such as generated by a Random Number Generator (RNG). In some embodiments, the RNG may comprise a first RNG (e.g., where a different RNG may be deemed to be a second RNG). According to some embodiments, the outcome may comprise an indication, output, and/or graphical display of a plurality of slot symbols. The outcome, for example, may be represented, defined, and/or indicated by a plurality of symbols (e.g., a matrix of slot symbols). According to some embodiments, each symbol of the plurality of symbols may be represented at (and/or assigned to) a particular position on one of the plurality of slot reels of the slot-style gaming interface. In some embodiments, the outcome may generally be defined as a result of a particular spin, game play, session, and/or other game play-related occurrence. In some embodiments, the outcome may comprise a first outcome (e.g., where a different and/or subsequent outcome may be deemed a second outcome; e.g., the first of a plurality of outcomes for a particular game, game type, session, player, tournament, etc.) and/or an outcome of a primary or base game (e.g., the slot-style game; e.g., another game being secondary, such as a bonus game).

According to some embodiments, the method 600 may comprise determining (e.g., by the processing device) whether the outcome of the slot-style game comprises a bonus symbol, at 606. It may be determined, for example, which of the slot symbols of the matrix of symbols comprise a bonus symbol (e.g., a symbol of some predefined type). In some embodiments, a bonus symbol position in the matrix of symbols may be determined. The outcome may comprise, for example, a bonus symbol in the third position of the third slot reel (e.g., in the case that the slot-style game comprises at least three (3) reels, each reel having at least three (3) symbol positions)—e.g., identified as position “3-3” or “3:3”. According to some embodiments, the determining at 606 may instead comprise a determination of whether the bonus game is triggered based on some other bonus triggering event other than an occurrence of a bonus symbol in the outcome of the slot-style game (e.g., an amount of elapsed time, a spin or play speed or rate, coin-in, deposit, win, and/or loss thresholds, weather events, sporting events, player attributes, actual or perceived player value, etc.). In some embodiments, such as in the case that a bonus symbol is determined to exist within the matrix of symbols comprising the outcome, the bonus symbol may comprise a first symbol (e.g., where a different symbol may be deemed to be a second symbol) and/or a first bonus symbol (e.g., where a different bonus symbol may be deemed to be a second bonus symbol) and the position of the first symbol/first bonus symbol may be described as a first position on a first one of the slot reels. In the case that it is determined that a bonus symbol occurrence exists in the outcome of the slot-style game (and/or another bonus triggering event has otherwise occurred), the method 600 may proceed to 608.

In some embodiments, the method 600 may comprise determining (e.g., by the processing device) a result of the slot-style game, at 608. According to some embodiments, the result may comprise a first result (e.g., where a different and/or subsequent result may be deemed to be a second result). In some embodiments, the first result may generally be determined in any known and/or desired manner such as by resolving one or more paylines (e.g., for the continuing example of the slot-style game) in accordance with the outcome symbol matrix to determine one or more payouts, wins, and/or other first results for the game. In some embodiments, the first result(s) may be utilized, along with a paytable, to determine one or more first payouts, win amounts, and/or other prizes and/or achievements. In some embodiments, the paytable may comprise a first paytable (e.g., where a different paytable may be deemed to be a second paytable).

According to some embodiments, the method 600 may comprise outputting (e.g., by and/or via the processing device) the result of the slot style game, at 610. The result (e.g., the first result) of the slot-style game may be output to a player of the slot-style game, for example, via a Graphical User Interface (GUI) and/or other interfaces associated with play of the game, such as the slot-style gaming interface provided at 602. According to some embodiments, the result may be utilized to further determine an outcome (and/or result) for a bonus and/or multiplayer game. The player may receive winnings for the first result, for example, and the result may further influence and/or govern play of a bonus, secondary, and/or multiplayer game such as the multiplayer-networked game. In some embodiments, the result may be output directly such as via an output device or an outputting of the result may be caused and/or facilitated. A server device that determines, generates, and/or renders or defines the result, for example, may send one or more command, instruction, and/or triggering signals to a device of the player, such signals including information that causes the player device to output one or more indications of the result (e.g., via and/or as part of the slot-style gaming interface).

In the case that it is determined that a bonus symbol occurrence does not exist in the outcome of the slot-style game (and/or another bonus triggering event has not otherwise occurred), the method 600 may proceed to 612. At 612, for example, the method 600 may comprise populating (e.g., by the processing device) an associated bonus area. One of the plurality of reel-tied bonus areas and/or elements of the slot-style gaming interface may, for example, be populated with and or assigned a particular value. According to some embodiments, the populating may be based on the determining that the first one of the plurality of symbols comprises the first bonus symbol represented at the first particular position on the first one of the plurality of slot reels. In some embodiments, such as in the exemplary “trap-door” embodiment described herein, the populating may comprise assigned a first value to a first bonus value accumulation area (e.g., a first rap door area) associated with the first one of the plurality of slot reels on which the bonus symbol (e.g., the first bonus symbol) occurred. In some embodiments, the populating may comprise outputting (and/or causing an outputting) an animation and/or graphical representation (e.g., a particular icon or image) of value being assigned to the associated bonus area (e.g., the first bonus value accumulation area).

In some embodiments, the method 600 may comprise determining (e.g., by the processing device) whether a number of bonus symbols in the outcome (e.g., in the symbol matrix) satisfies a predetermined bonus trigger threshold, at 614. In some embodiments, one or more other bonus triggers may also or alternatively be determined at 614. In some embodiments, the symbol matrix of the outcome (e.g., of the first outcome) of the slot-style game may be scanned, queried, and/or analyzed to determine a total number of bonus symbols (or symbols of a certain type) present and/or represented therein. The number of determined bonus symbols of the outcome may, for example, be compared to one or more predetermined thresholds (e.g., a bonus game triggering threshold) to determine if a condition for initiating a bonus game is satisfied. According to some embodiments, such as in the case that the number of bonus symbols of the outcome (e.g., three (3) bonus symbols, for example) equals or exceeds a threshold value (e.g., a threshold of three (3) bonus symbols), a bonus game may be triggered. In the case that it is determined that the number of bonus symbols in the outcome (e.g., the first outcome) does not exceed the bonus trigger threshold, the method 600 may proceed to 610. In the case that it is determined that the number of bonus symbols in the outcome (e.g., the first outcome) does exceed the bonus trigger threshold, the method 600 may proceed to 616. In some embodiments, other conditions may also or alternatively need to be satisfied to cause the method to proceed to 616.

According to some embodiments, the method 600 may comprise initiating (e.g., by the processing device) a bonus game, at 616. The bonus game may be provided in many forms, styles, and/or configurations as is or becomes desirable and/or practicable. In the ongoing “trap door” slot-style game described herein, for example, the bonus game may comprise a spinning of the reels of the primary game (e.g., the slot-style game) and one or more bonus elements (e.g., representing trap doors) that are reactive thereto. A trap door bonus area or element associated with and/or assigned a value, such as a stack of cash (e.g., represented in the slot-style gaming interface as a graphical representation of one or more stacks of cash), for example, may be reactive to outcomes achieved via the reels of the slot-style game and/or may be separately reactive to a different RNG event and/or trigger. According to some embodiments, the initiation of the bonus game may comprise notifying the player that a bonus game or round has been earned, achieved, and/or activated. The player may be provided with bonus game instructions, paytable(s), odds, and/or be permitted to provide input regarding the bonus game and/or initiation and/or play thereof.

In some embodiments, for example, the method 600 may proceed by determining (e.g., by the processing device) if amounts associated with the bonus areas are to be adjusted, at 618. In the case that a plurality of bonus areas and/or elements are provided (e.g., via the slot-style gaming interface), for example, one or more values associated with and/or assigned to such areas/elements may be adjusted by the player and/or at the request of the player. In the case of a three (3)-reel slot-style game, for example, and each slot reel being tied to a particular bonus area/element, each bonus area/element may be assigned a value (e.g., populated at 612 based on outcomes of the slot-style/primary game)—such as reel number one equals one hundred (100), reel number two equals ten (10), and reel number three equals ninety (90). In some embodiments, the player may be presented with an option to adjust or alter these values amongst the areas/elements, such as by redistributing the total value (e.g., two hundred (200) amongst the areas/elements as desired. The player may be allowed to manually adjust the individual values, for example, and/or may be provided with one or more pseudo-automatic adjustment options such as a “random” option (e.g., that randomly redistributes the total value amongst the bonus areas/elements on behalf of the player) and/or an “even” option (e.g., that redistributes the total value equally amongst the areas/elements). In some embodiments, the determining may comprise receiving a bonus are/element adjustment request and/or receiving a bonus area/element value adjustment indication, from a device of the player. In the case that it is determined that the bonus areas/elements (or a single bonus area/element) is desired to be adjusted, the method 600 may proceed to 620.

According to some embodiments, for example, the method 600 may comprise adjusting (e.g., by the processing device) the bonus area amounts, at 620. In the case that a player-defined redistribution of the bonus area/element values is determined, for example, the values may be redistributed in the manner defined by the player. The player may provide an instruction to the processing device (and the processing device may accordingly receive the instruction), for example, to keep the value of one hundred (100) assigned to the first bonus area/element, but move (e.g., reallocate) the value of ten (10) from the second area/element to the third area/element, bringing the value of the second area/element to zero (0) and bringing the value of the third area/element to one hundred (100)—e.g., while the total value assigned to all of the bonus areas/elements remains at two hundred (200). In the case that the player elects to have the values redistributed automatically, an indication from the player may be indicative of a selection of a “random”, “equal”, and/or other automatic redistribution methodology desired to be implemented. The processing device may then (e.g., in response to the players choice), for example, implement a set of stored instructions assigned to the particular methodology selected by the player such as a random redistribution methodology (e.g., that randomly reallocates the total bonus area/element value amongst the available bonus areas/elements), an equally-distributed redistribution methodology (e.g., that equally redistributes the total bonus area/element value amongst the available bonus areas/elements), etc.

In the case that it is determined that the bonus areas/elements (or a single bonus area/element) are not desired to be adjusted and/or in the case that the bonus areas/elements have been adjusted at 620, the method 600 may proceed to 622.

In some embodiments, for example, the method 600 may comprise initiating (e.g., by the processing device) a free spin, at 622. The free spin may, for example, comprise a free spin of the reels of the primary game and/or reels or other game play mechanics of the bonus game. According to some embodiments, the bonus game may comprise the free spins of the primary slot-style reels in accordance with the primary game with added functionality with respect to the now active bonus areas/elements.

According to some embodiments, for example, the method 600 may comprise determining (e.g., by the processing device) an outcome of the free spin, at 624. In some embodiments, the outcome of the free spin may comprise a second outcome of the primary game. The outcome (e.g., a second outcome in some embodiments) may, for example, be determined utilizing the same RNG and/or RNG methodology as was utilized to achieve and/or determine the first outcome (e.g., of the primary game)—e.g., an extension of the primary game play. According to some embodiments, the second outcome may comprise a second slot-symbol matrix. In some embodiments, the outcome of the free spin may comprise an outcome of the bonus game. The outcome of the free spin may, for example, be determined utilizing a different RNG (e.g., a second RNG) and/or RNG methodology than was utilized to determine the first outcome of the primary slot-style game.

In some embodiments, the method 600 may comprise determining (e.g., by the processing device) a result of the free spin, at 626. According to some embodiments, the result may comprise a second result (e.g., where the result is different and/or subsequent to the first result). In some embodiments, the second result may generally be determined in any known and/or desired manner such as by resolving one or more paylines (e.g., for the continuing example of the slot-style game) in accordance with the outcome symbol matrix of the second outcome to determine one or more payouts, wins, and/or other first results for the game. In some embodiments, the second result(s) may be utilized, along with a paytable, to determine one or more second payouts, win amounts, and/or other prizes and/or achievements. In some embodiments, the paytable may comprise a second paytable (e.g., different than the first paytable).

According to some embodiments, such as in the case that a free spin feature is not desired as part of the method 600, the initiating at 622, the determining of the outcome at 624, and/or the determining of the result at 626 may not be included in the method 600 or may be replaced with different bonus and/or primary game features. According to some embodiments for example, the bonus game may progress and/or occur during a resumed and/or continued normal play of the primary slot-style game, with no free spins.

In some embodiments, the method 600 may comprise determining (e.g., by the processing device) an outcome of the bonus game, at 628. The outcome of the bonus game (e.g., a third outcome in some embodiments) may, for example, be determined utilizing the same RNG and/or RNG methodology as was utilized to achieve and/or determine the first and/or second outcomes (e.g., of the primary game). According to some embodiments, the outcome of the bonus game may be determined utilizing a different RNG (e.g., a second or even third RNG) and/or RNG methodology than was utilized to determine the first and/or second outcomes of the primary slot-style game. In some embodiments, and continuing the “trap door”-themed example described herein, the outcome of the bonus game may comprise a removal, clearing, emptying, and/or zeroing of one or more of the bonus areas/elements and/or values thereof. The outcome of the bonus game may comprise, for example, an opening of the trap door comprising the first bonus area/element, such opening causing (and/or being represented by) a falling, disposal, and/or disappearance of any value accumulated thereon (e.g., the example one hundred (100) assigned to the first bonus area/element would be deleted or removed, providing a new assigned value of zero (0)).

The outcome, for example, may define a selection of a first one of the bonus value accumulation areas from the plurality of bonus value accumulation areas. According to some embodiments, all bonus value associated with a selected bonus area/element may be removed and/or deleted (e.g., all accumulated cash on the first trap door falls through the door and is gone). In some embodiments, only a portion of the value of the selected bonus area/element may be removed and/or deleted (e.g., a value of ten (10) may be removed by falling through the first trap door or a portion of the door that falls away, leaving a value of ninety (90)). In some embodiments, the percentage and/or amount of value removed and/or retained may be predetermined (e.g., set to a default of all, or ten (10)) or may be dynamically determined such as based on a random number determination (e.g., a third or even fourth RNG and/or RNG determination).

According to some embodiments, the method 600 may comprise determining (e.g., by the processing device) whether more than one bonus area remains populated, at 630. In the case that more than one bonus area/element remains populated and/or assigned a value, the method 600 may proceed back to initiate another free spin at 622 (and/or otherwise continue bonus round play). In the case that only a single bonus area/element remains as having not been selected based on bonus game outcomes, the single remaining (e.g., process of elimination) bonus area/element may be utilized to determine a result of the bonus game at 632.

In some embodiments, for example, the method 600 may comprise determining (e.g., by the processing device) a result of the bonus game, at 632. The result of the bonus game may, for example, be based on the outcome(s) of the bonus game (e.g., a third outcome in some embodiments) determined at 628. In the case that a plurality of outcomes of the bonus game have been determined at 628, for example, and the effect of the outcomes is a removal and/or zeroing of all value from all but one of the plurality of bonus areas/elements, the last remaining bonus area/element may be utilized to determine the result of the bonus game. According to some embodiments, the value assigned to the last remaining bonus area/element may define the magnitude of the result. According to some embodiments, the result of the bonus game may comprise a third result (e.g., where the result of the bonus game is different and/or subsequent to the first and/or second results). In some embodiments, the third result may generally be determined in any known and/or desired manner such as by resolving one or more variables and/or values in accordance with the third outcome (e.g., the outcome of the bonus game) to determine one or more payouts, wins, and/or other first results for the bonus game. In some embodiments, the third result may be utilized, along with a paytable, to determine one or more third and/or bonus payouts, win amounts, and/or other prizes and/or achievements. In some embodiments, the paytable may comprise a third and/or bonus paytable (e.g., different than the first, second, and/or primary game paytable).

According to some embodiments, after determining either or both of (i) the free spin result at 626 or (ii) the bonus game result at 632, the method 600 may proceed to the outputting of the results at 610. In some embodiments, one or more of the results (e.g., of the primary and/or bonus games) may be combined. Any or all of the primary game result determined at 608, the free spin result determined at 626, and the bonus game result determined at 632, for example, may be added, multiplied, combined, and/or otherwise interfaced with each other such as to produce and/or define a total result output at 610. According to some embodiments, each play of the primary game may result in a first win amount added to a credit meter of a player (and/or a wager amount may be deducted from the credit mater, such as in the case of a wagering game), each play of the free spin portion of the bonus game may result in a second win amount added to the credit meter (with no credits being deducted for wagers in the case of free spins), and the final result of the “trap door” bonus game may result in a third win amount added to the credit meter (e.g., an amount of credits assigned to the last remaining trap door in the bonus game)

In some embodiments, the beginning, end, and/or composition of the bonus game may differ. While the method 600 is depicted as initiating the bonus game at 616, for example, the processes at 618 and/or 620 may instead occur prior to bonus game initiation (e.g., they may not comprise a portion of the bonus game), and the bonus game may instead initiate upon the initiation of the free spin(s) at 622. Similarly, the free spin processes/features may not be included in the bonus game. The bonus game may simply comprise, for example, a determination of which bonus area/element is selected/chosen for defining an outcome and/or result of the bonus game. Other variations to the precise order of gaming processes, configuration of elements and/or features, and/or incorporation of themes and/or graphical elements may also or alternatively be included in the method 600 without deviating from the scope of some embodiments.

Referring now to FIG. 7A, FIG. 7B, FIG. 7C, FIG. 7D, FIG. 7E, FIG. 7F, and FIG. 7G, example interfaces 720a-h according to some embodiments are shown. In some embodiments, the interfaces 720a-h may comprise a web page, web form, database entry form, Application Programming Interface (API), spreadsheet, table, and/or application or other GUI via which a game may be accessed and/or played. The interfaces 720a-h may, for example, comprise a front-end of a social network game, wagering game, casual game, and/or online gaming program (and/or portion thereof) and/or platform programmed and/or otherwise configured to execute, conduct, and/or facilitate the method 600 of FIG. 6, and/or portions thereof. In some embodiments, the interfaces 720a-h may be output via a computerized device such as one or more of the user devices 102a-n, 202a-n, 302a-b, 402, 502 and/or the servers 110, 210a-n, 310a-g, 410e-f, 510a-j of FIG. 1, FIG. 2, FIG. 3, FIG. 4, and/or FIG. 5 herein. In some embodiments, the example interfaces 720a-h may comprise interface outputs of (and/or otherwise associated with) a GUI utilized to play a slot-style game having reel-tied bonus areas and/or player-adjustable bonus value distributions as described herein.

A first example interface 720a as depicted in FIG. 7A, for example, may comprise a primary outcome area 722 (e.g., in the case of the depicted slot-style game, comprising a plurality of slot reels 724a-e and/or a first payline 726a) configured to output indications descriptive of and/or associated with a primary game (e.g., a plurality of game symbols 728 such as may comprise a matrix of such symbols 728) and/or a secondary outcome area 730 configured to output indications descriptive of and/or associated with a secondary (e.g., bonus) game. In some embodiments, the secondary outcome area 730 may comprise a plurality of bonus accumulation elements 732a-e (e.g., “trap doors” in the depicted example “trap door” slot-style game). According to some embodiments, each bonus accumulation element 732a-e may be associated with, assigned to, tied to, and/or otherwise connected to each respective (e.g., similarly-lettered) slot reel 724a-e. In some embodiments, the plurality of game symbols 728 may comprise one or more bonus symbols 728-1 (e.g., graphical representations associated with functionality and/or outcomes of the bonus game) and/or one or more winning symbols 728-2 (e.g., graphical representations associated with a winning outcome of the primary slot-style game). In some embodiments, for example, a winning result in the slot-style game (e.g., a primary game) may be determined in accordance with the first payline 726a. Along the first payline 726a, for example, three (3) diagonally-adjacent “A” symbols 728-2a, 728-2b, and 728-2c may comprise a winning result and/or be indicative of a winning outcome.

For ease of reference with respect to different depicted game symbols 728 (and/or bonus symbols 728-1 and/or winning symbols 728-2), each symbol 728 may be identified herein (e.g., uniquely for any particular primary outcome area 722) by reference to a combination of the letter designations of the corresponding reel 724a-e and a position vertically on the reel 724a-e, numbered consecutively from top to bottom from one (1) to, for example, three (3). The “DROP” game symbol 728 may be identified, for example, as “d-1”—i.e., occurring on the fourth reel 724d at the first position thereof. According to some embodiments, the first example game interface 720a may comprise a spin area 760, a wager area 762 (e.g., that indicates and/or allows changes to the size of wager/play amount and/or number of paylines played), a credit area 764, a win area 766 (e.g., that indicates that the first payline 726a has won ten (10) credits—which may also or alternatively be reflected in the graphic depicting a highlighting of winning symbols 728-2a, 728-2b, and 728-2c), and/or a paytable area 768 (e.g., that allows a user to view, access, and/or interact with one or more paytables applicable to the slot-style game and/or bonus game for which the first example interface 720a comprises an exemplary output indication of).

According to some embodiments, the bonus symbol 728-1 depicted at “b-1” in the slot-symbol matrix output by the exemplary primary outcome area 722 of the first example interface 720a may be associated with a population and/or assignment of value to the respective second bonus accumulation element 732b. The occurrence of the bonus symbol 728-1 may, for example, cause a value of twenty-five (25), as depicted, to be assigned to the second bonus accumulation element 732b. In some embodiments, the assignment and/or population of the value may comprise and/or be associated with (e.g., accompanied and/or represented by) one or more graphical representations and/or animations. As depicted, for example, a graphical image of a stack of cash (e.g., representing a value of twenty-five (25)) may progress from a starting point “(1)” as part of and/or being superimposed on the bonus symbol 728-1, along the dotted travel path depicted in FIG. 7A in parallel with the second reel 724b, to the second bonus accumulation element 732b (e.g., the second “trap door”; “(2)”). In such a manner, for example, players may be able to readily visualize the contribution of a bonus symbol 728-1 to value accumulated in the bonus accumulation elements 732a-e.

In some embodiments, a second example interface 720b as depicted in FIG. 7B may also or alternatively provide an indication of the slot-style game (and/or associated bonus or secondary game). The second example interface 720b may, for example, comprise an alternate, previous, subsequent, and/or modified version of the first example interface 720a. The second example interface 720b, in accordance with some embodiments, may depict a second outcome of the primary game represented by a second slot symbol matrix in the primary outcome area 722. As depicted, the first reel 724a may comprise a first bonus symbol 728-1a that populates (and/or is depicted or animated as populating) a first bonus accumulation element 732a (e.g., for a first time, and accordingly with a default amount of twenty-five (25)—or the value being based on the wager amount of the player), and the second reel 724b may comprise a second bonus symbol 728-1b that is associated with an additional value of twenty-five (25) being assigned to the second bonus accumulation area 732b (e.g., for a total second bonus accumulation amount of fifty (50)).

According to some embodiments, a third example interface 720c as depicted in FIG. 7C may also or alternatively provide an indication of the slot-style game (and/or associated bonus or secondary game). The third example interface 720c may, for example, comprise an alternate, previous, subsequent, and/or modified version of the first example interface 720a and/or the second example interface 720b. The third example interface 720c, in accordance with some embodiments, may depict a third outcome (third being either merely subsequent to the first two outcomes or in some embodiments being a third consecutive outcome) of the primary game represented by a third slot symbol matrix in the primary outcome area 722. As depicted, all bonus accumulation elements 732a-e have been assigned a value, each such value being represented by a graphical representation of piles of cash (each such pile comprising a plurality of individual stacks of cash, e.g., representing equal values—such as twenty-five (25), as utilized in the ongoing example). In some embodiments, such as in the case of the third outcome and representative symbol matrix of FIG. 7C, a number of occurrences of bonus symbols 728-1 may equal or exceed a bonus triggering threshold. In the case that the bonus triggering threshold is two (2) or three (3), for example, the three (3) occurrences of bonus symbols 728-1 in the primary outcome area 722 of the third example interface 720c may be determined to have accordingly met or exceeded such threshold and thus triggered a bonus round or game.

In some embodiments, a fourth example interface 720d as depicted in FIG. 7D may also or alternatively provide an indication of the slot-style game (and/or associated bonus or secondary game). The fourth example interface 720d may, for example, comprise an alternate, previous, subsequent, and/or modified version of the first example interface 720a, the second example interface 720b, and/or the third example interface 720c. The fourth example interface 720d, in accordance with some embodiments, may depict a bonus accumulation distribution screen. The bonus accumulation distribution screen may, for example, be triggered by the occurrence of the three (3) bonus symbols 728-1 of the third example interface 720c and/or may comprise and/or be associated with an initiation of a bonus round or game. The fourth example interface 720d may comprise, for example, a plurality of bonus accumulation distribution sliders 740a-e, each slider comprising an interface mechanism that allows a player to redistribute the total amount of bonus value accumulations across the plurality of bonus accumulation elements 732a-e. As depicted, for example, the total bonus accumulation value of one thousand two hundred and fifty (1250) has been redistributed with respect to the distribution depicted in FIG. 7C, with a value of fifty (50) remaining to be reallocated and/or assigned (e.g., as depicted in an unallocated value window 742). In some embodiments, the fourth example interface 720d may comprise one or more automatic distribution buttons 744a-b. A first automatic distribution button 744a may cause the total bonus accumulation value to be evenly distributed across and/or amongst the bonus accumulation elements 732a-e (e.g., an “EVEN” distribution function), for example, while a second automatic distribution button 744b may cause the total bonus accumulation value to be randomly distributed across and/or amongst the bonus accumulation elements 732a-e (e.g., a “RANDOM” distribution function).

According to some embodiments, a fifth example interface 720e as depicted in FIG. 7E may also or alternatively provide an indication of the slot-style game (and/or associated bonus or secondary game). The fifth example interface 720e may, for example, comprise an alternate, previous, subsequent, and/or modified version of the first example interface 720a, the second example interface 720b, the third example interface 720c, and/or the fourth example interface 720e. The fifth example interface 720e, in accordance with some embodiments, may depict a fourth outcome (fourth being either merely subsequent to the first three outcomes or in some embodiments being a fourth consecutive outcome) of the primary game represented by a fourth slot symbol matrix in the primary outcome area 722. In some embodiments, such as in the case that the fifth example interface 720e depicts an active bonus game state, the fourth outcome may comprise a first outcome of a free spin. According to some embodiments, the outcome of the free spin may be resolved and/or determined in the same manner as standard outcomes of the primary game, for example, but may simply not debit wagers from the player's credit balance. As depicted, and in accordance with some embodiments, a bonus symbol 728-1 occurrence in the symbol matrix may continue to add value to associated bonus accumulation elements 732a-e (e.g., the second bonus accumulation element 732b in the example depicted in FIG. 7E). Not explicitly depicted in FIG. 7E is the operation of the determination of outcomes of the bonus game. FIG. 7E may depict, for example, an instance where none of the bonus accumulation elements 732a-e is randomly selected by the bonus game for opening of the associated “trap door”.

In some embodiments, a sixth example interface 720f as depicted in FIG. 7F may also or alternatively provide an indication of the slot-style game (and/or associated bonus or secondary game). The sixth example interface 720f may, for example, comprise an alternate, previous, subsequent, and/or modified version of the first example interface 720a, the second example interface 720b, the third example interface 720c, the fourth example interface 720d, and/or the fifth example interface 720e. The sixth example interface 720f, in accordance with some embodiments, may depict a state where the first bonus accumulation element 732a has been cleared of value (e.g., the first “trap door” has been opened, taking away the value previously populated on the first trap door), such as in response to an outcome of the bonus game. The outcome (e.g., a first outcome of the bonus game) of the bonus game may, for example, identify and/or select the first bonus accumulation area 732a for value clearing/deletion. According to some embodiments, the sixth example interface 720f may also depict a fifth outcome (fifth being either merely subsequent to the first four outcomes or in some embodiments being a fifth consecutive outcome) of the primary game represented by a fifth slot symbol matrix in the primary outcome area 722. As depicted, the fifth outcome may comprise a plurality of winning symbols 728-2d, 728-2e, 728-2f disposed along a second payline 726b. According to some embodiments, the winning outcome along the second payline 726b may be supplemented by a first stacked wild symbol 750a. The first stacked wild symbol 750a may, for example, be generated and/or activated in connection with the first outcome of the bonus game. The clearing of value from the first bonus accumulation feature 732a, for example, may cause the first stacked wild symbol 750a to be generated on the associated first reel 724a. In some embodiments, the first stacked wild symbol 750a may persist for a number of spins of the primary game and/or for a number of free spins (e.g., one or more spins). In some embodiments, a “stacked wild symbol” may be defined as described in co-pending International Patent Application PCT/1B2014/000423 filed on Feb. 21, 2014 and titled “SYSTEMS AND METHODS FOR PLACEMENT OF WILD SYMBOLS IN A GAME” [Attorney Docket No. GS01-020-02], the stacked wild symbol concepts and descriptions of which are hereby incorporated by reference herein.

According to some embodiments, a seventh example interface 720g as depicted in FIG. 7G may also or alternatively provide an indication of the slot-style game (and/or associated bonus or secondary game). The seventh example interface 720g may, for example, comprise an alternate, previous, subsequent, and/or modified version of the first example interface 720a, the second example interface 720b, the third example interface 720c, the fourth example interface 720d, the fifth example interface 720e, and/or the sixth example interface 720f. The seventh example interface 720g, in accordance with some embodiments, may depict a state where both the first bonus accumulation element 732a and the fifth bonus accumulation element 732e have been cleared of value (e.g., the first and fifth “trap doors” have been opened, taking away the values previously populated on the first and fifth trap doors), such as in response to a subsequent (e.g., second) outcome of the bonus game. The second outcome of the bonus game may, for example, identify and/or select the fifth bonus accumulation area 732e for value clearing/deletion. According to some embodiments, the seventh example interface 720g may also depict a sixth outcome (sixth being either merely subsequent to the first five outcomes or in some embodiments being a sixth consecutive outcome) of the primary game represented by a sixth slot symbol matrix in the primary outcome area 722. As depicted, the sixth outcome may comprise a plurality of winning symbols 728-2g, 728-2h, 728-2i disposed along a third payline 726c. According to some embodiments, the sixth symbol matrix may comprise a second stacked wild symbol 750b. The second stacked wild symbol 750b may, for example, be generated and/or activated in connection with the second outcome of the bonus game. The clearing of value from the fifth bonus accumulation feature 732e, for example, may cause the second stacked wild symbol 750b to be generated on the associated fifth reel 724e. In some embodiments, the second stacked wild symbol 750b may persist for a number of spins of the primary game and/or for a number of free spins (e.g., one or more spins).

In some embodiments, an eighth example interface 720h as depicted in FIG. 7H may also or alternatively provide an indication of the slot-style game (and/or associated bonus or secondary game). The eighth example interface 720h may, for example, comprise an alternate, previous, subsequent, and/or modified version of the first example interface 720a, the second example interface 720b, the third example interface 720c, the fourth example interface 720d, the fifth example interface 720e, the sixth example interface 720f, and/or the seventh example interface 720g. The eighth example interface 720h, in accordance with some embodiments, may depict only the third bonus accumulation element 732c remains as having not been cleared of value (e.g., the third “trap doors” is the only one to not have been opened during play of the bonus game), such as in response to a plurality of outcomes of the bonus game. According to some embodiments, the occurrence of a last-remaining bonus accumulation element 732c may cause the bonus game to end. The value associated with and/or assigned to the third bonus accumulation element 732c may, for example, comprise (and/or define) a result of the bonus game. As depicted, for example, the value of fifty (50) may, in some embodiments, be added to the player's credit balance (and/or added to a result of winning symbols 728-2j, 728-2k, 728-2l disposed along a fourth payline 726d; e.g., a result of the primary game and/or of a free spin) as a result of the bonus game. In some embodiments, the result of the bonus game may be provided in addition to any result achieved from the final outcome of the free spins displayed in the primary outcome area 722.

While various components of the interfaces 720a-h have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Turning to FIG. 8, a block diagram of an apparatus 810 according to some embodiments is shown. In some embodiments, the apparatus 810 may be similar in configuration and/or functionality to any of the player and/or user devices 102a-n, 202a-n, 302a-b, 402, 502 and/or the servers and/or controller devices 110, 210a-n, 310a-g, 410e-f, 510a-j of FIG. 1, FIG. 2, FIG. 3, FIG. 4, and/or FIG. 5 herein, and/or may otherwise comprise a portion of the systems 100, 200, 300, 400, 500 of FIG. 1, FIG. 2, FIG. 3, FIG. 4, and/or FIG. 5 herein. The apparatus 810 may, for example, execute, process, facilitate, and/or otherwise be associated with the method 600 of FIG. 6 and/or other various methods described herein, and/or any portions and/or combinations thereof. In some embodiments, the apparatus 810 may comprise a processing device 812, an input device 814, an output device 816, a communication device 818, an interface 820, a memory device 840 (storing various programs and/or instructions 842 and data 844), and/or a cooling device 850. According to some embodiments, any or all of the components 812, 814, 816, 818, 820, 840, 842, 844, 850 of the apparatus 810 may be similar in configuration and/or functionality to any similarly named and/or numbered components described herein. Fewer or more components 812, 814, 816, 818, 820, 840, 842, 844, 850 and/or various configurations of the components 812, 814, 816, 818, 820, 840, 842, 844, 850 be included in the apparatus 810 without deviating from the scope of embodiments described herein.

According to some embodiments, the processing device 812 may be or include any type, quantity, and/or configuration of electronic and/or computerized processor that is or becomes known. The processing device 812 may comprise, for example, an Intel® IXP 2800 network processor or an Intel® XEON™ Processor coupled with an Intel® E7501 chipset. In some embodiments, the processing device 812 may comprise multiple inter-connected processors, microprocessors, and/or micro-engines. According to some embodiments, the processing device 812 (and/or the apparatus 810 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 810 comprises a server such as a blade server, necessary power may be supplied via a standard AC outlet, power strip, surge protector, a PDU, and/or Uninterruptible Power Supply (UPS) device.

In some embodiments, the input device 814 and/or the output device 816 are communicatively coupled to the processing device 812 (e.g., via wired and/or wireless connections and/or pathways) and they may generally comprise any types or configurations of input and output components and/or devices that are or become known, respectively. The input device 814 may comprise, for example, a keyboard that allows an operator of the apparatus 810 to interface with the apparatus 810 (e.g., by a player, such as to participate in an online game session as described herein). In some embodiments, the input device 814 may comprise a sensor configured to provide information such as player relationships to the apparatus 810 and/or the processing device 812. The output device 816 may, according to some embodiments, comprise a display screen and/or other practicable output component and/or device. The output device 816 may, for example, provide a game interface (such as the interface 820 and/or the interfaces 720a-h of FIG. 7A, FIG. 7B, FIG. 7C, FIG. 7D, FIG. 7E, FIG. 7F, FIG. 7G, and/or FIG. 7H herein) to a player (e.g., via a website). According to some embodiments, the input device 814 and/or the output device 816 may comprise and/or be embodied in a single device such as a touch-screen monitor.

In some embodiments, the communication device 818 may comprise any type or configuration of communication device that is or becomes known or practicable. The communication device 818 may, for example, comprise a NIC, a telephonic device, a cellular network device, a router, a hub, a modem, and/or a communications port or cable. In some embodiments, the communication device 818 may be coupled to provide data to a player device (not shown in FIG. 8), such as in the case that the apparatus 810 is utilized to provide a game interface to a player as described herein. The communication device 818 may, for example, comprise a cellular telephone network transmission device that sends signals indicative of game interface components to customer and/or subscriber handheld, mobile, and/or telephone device. According to some embodiments, the communication device 818 may also or alternatively be coupled to the processing device 812. In some embodiments, the communication device 818 may comprise an IR, RF, Bluetooth™, NFC, and/or Wi-Fi® network device coupled to facilitate communications between the processing device 812 and another device (such as a player device and/or a third-party device).

The memory device 840 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 840 may, according to some embodiments, store one or more of game instructions 842-1, interface instructions 842-2, player data 844-1, game data 844-2, tournament data 844-3, and/or prize data 844-4. In some embodiments, the game instructions 842-1, interface instructions 842-2, player data 844-1, game data 844-2, tournament data 844-3, and/or prize data 844-4 may be utilized by the processing device 812 to provide output information via the output device 816 (and/or the interface 820) and/or the communication device 818.

According to some embodiments, the game instructions 842-1 may be operable to cause the processing device 812 to process the player data 844-1, game data 844-2, tournament data 844-3, and/or prize data 844-4. Player data 844-1, game data 844-2, tournament data 844-3, and/or prize data 844-4 received via the input device 814 and/or the communication device 818 may, for example, be analyzed, sorted, filtered, decoded, decompressed, ranked, scored, plotted, and/or otherwise processed by the processing device 812 in accordance with the game instructions 842-1. In some embodiments, player data 844-1, game data 844-2, tournament data 844-3, and/or prize data 844-4 may be fed by the processing device 812 through one or more mathematical and/or statistical formulas and/or models in accordance with the game instructions 842-1 to provide online game sessions and/or implement, facilitate, and/or output a slot-style game having reel-tied bonus areas and/or player-adjustable bonus value distributions as described herein.

In some embodiments, the interface instructions 842-2 may be operable to cause the processing device 812 to process the player data 844-1, game data 844-2, tournament data 844-3, and/or prize data 844-4. Player data 844-1, game data 844-2, tournament data 844-3, and/or prize data 844-4 received via the input device 814 and/or the communication device 818 may, for example, be analyzed, sorted, filtered, decoded, decompressed, ranked, scored, plotted, and/or otherwise processed by the processing device 812 in accordance with the interface instructions 842-2. In some embodiments, player data 844-1, game data 844-2, tournament data 844-3, and/or prize data 844-4 may be fed by the processing device 812 through one or more mathematical and/or statistical formulas and/or models in accordance with the interface instructions 842-2 to provide online game sessions and/or implement, facilitate, and/or output a slot-style game having reel-tied bonus areas and/or player-adjustable bonus value distributions as described herein.

Any or all of the exemplary instructions and data types described herein and other practicable types of data may be stored in any number, type, and/or configuration of memory devices that is or becomes known. The memory device 840 may, for example, comprise one or more data tables or files, databases, table spaces, registers, and/or other storage structures. In some embodiments, multiple databases and/or storage structures (and/or multiple memory devices 840) may be utilized to store information associated with the apparatus 810. According to some embodiments, the memory device 840 may be incorporated into and/or otherwise coupled to the apparatus 810 (e.g., as shown) or may simply be accessible to the apparatus 810 (e.g., externally located and/or situated).

In some embodiments, the apparatus 810 may comprise a cooling device 850. According to some embodiments, the cooling device 850 may be coupled (physically, thermally, and/or electrically) to the processing device 812 and/or to the memory device 840. The cooling device 850 may, for example, comprise a fan, heat sink, heat pipe, radiator, cold plate, and/or other cooling component or device or combinations thereof, configured to remove heat from portions or components of the apparatus 810.

Referring to FIG. 9A, FIG. 9B, FIG. 9C, FIG. 9D, and FIG. 9E, perspective diagrams of exemplary data storage devices 940a-e according to some embodiments are shown. The data storage devices 940a-e may, for example, be utilized to store instructions and/or data such as the game instructions 842-1, interface instructions 842-2, player data 844-1, game data 844-2, tournament data 844-3, and/or prize data 844-4, each of which is described in reference to FIG. 8 herein. In some embodiments, instructions stored on the data storage devices 940a-e may, when executed by a processing device, cause the implementation of and/or facilitate the method 600 of FIG. 6 and/or portions thereof.

According to some embodiments, the first data storage device 940a may comprise one or more various types of internal and/or external hard drives. The first data storage device 940a may, for example, comprise a data storage medium 946 that is read, interrogated, and/or otherwise communicatively coupled to and/or via a disk reading device 948. In some embodiments, the first data storage device 940a and/or the data storage medium 946 may be configured to store information utilizing one or more magnetic, inductive, and/or optical means (e.g., magnetic, inductive, and/or optical-encoding). The data storage medium 946, depicted as a first data storage medium 946a for example (e.g., breakout cross-section “A”), may comprise one or more of a polymer layer 946a-1, a magnetic data storage layer 946a-2, a non-magnetic layer 946a-3, a magnetic base layer 946a-4, a contact layer 946a-5, and/or a substrate layer 946a-6. According to some embodiments, a magnetic read head 946a may be coupled and/or disposed to read data from the magnetic data storage layer 946a-2.

In some embodiments, the data storage medium 946, depicted as a second data storage medium 946b for example (e.g., breakout cross-section “B”), may comprise a plurality of data points 946b-2 disposed with the second data storage medium 946b. The data points 946b-2 may, in some embodiments, be read and/or otherwise interfaced with via a laser-enabled read head 948b disposed and/or coupled to direct a laser beam through the second data storage medium 946b.

In some embodiments, the second data storage device 940b may comprise a CD, CD-ROM, DVD, Blu-Ray™ Disc, and/or other type of optically-encoded disk and/or other storage medium that is or becomes know or practicable. In some embodiments, the third data storage device 940c may comprise a USB keyfob, dongle, and/or other type of flash memory data storage device that is or becomes know or practicable. In some embodiments, the fourth data storage device 940d may comprise RAM of any type, quantity, and/or configuration that is or becomes practicable and/or desirable. In some embodiments, the fourth data storage device 940d may comprise an off-chip cache such as a Level 2 (L2) cache memory device. According to some embodiments, the fifth data storage device 940e may comprise an on-chip memory device such as a Level 1 (L1) cache memory device.

The data storage devices 940a-e may generally store program instructions, code, and/or modules that, when executed by a processing device cause a particular machine to function in accordance with one or more embodiments described herein. The data storage devices 940a-e depicted in FIG. 9A, FIG. 9B, FIG. 9C, FIG. 9D, and FIG. 9E are representative of a class and/or subset of computer-readable media that are defined herein as “computer-readable memory” (e.g., non-transitory memory devices as opposed to transmission devices or media).

### IV. Rules of Interpretation

The terms “computer-readable medium” and “computer-readable memory”, as utilized herein, refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

In some embodiments, one or more specialized machines such as a computerized processing device, a server, a remote terminal, and/or a customer device may implement the various practices described herein. A computer system of an gaming entity may, for example, comprise various specialized computers that interact to provide for online games as described herein

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
determining, by a processing device, a plurality of symbols indicative of an outcome of a slot-style game, each symbol of the plurality of symbols being represented at a particular position on one of a plurality of slot reels of a game output interface, each slot reel of the game interface being associated with a respective bonus value accumulation area;
determining, by the processing device and based on a paytable of the slot-style game and based on the positions of the plurality of symbols indicative of the outcome, a result associated with the outcome of the slot-style game;
determining, by the processing device, that a first one of the plurality of symbols comprises a first bonus symbol represented at a first particular position on a first one of the plurality of slot reels;
populating, by the processing device and based on the determining that the first one of the plurality of symbols comprises the first bonus symbol represented at the first particular position on the first one of the plurality of slot reels, a first one of the bonus value accumulation areas associated with the first one of the plurality of slot reels;
determining, by the processing device and after the populating, that a bonus game is triggered;
determining, by the processing device, an outcome of the bonus game, the outcome defining a selection of the first one of the bonus value accumulation areas from the plurality of bonus value accumulation areas;
determining, by the processing device and based on the populating, a result associated with the outcome of the bonus game; and
causing, by the processing device and via the game output interface, an outputting of an indication of least one of: (i) the result of the slot-style game, and (ii) the result of the bonus game.

2. The method of claim 1, wherein the plurality of slot reels of the game output interface comprise five virtual slot reels.

3. The method of claim 1, wherein the outcome of the slot-style game is determined based on a first result of a random number generator.

4. The method of claim 3, wherein the outcome of the bonus game is determined based on a second result of the random number generator

5. The method of claim 1, further comprising:
providing, to a player of the slot-style game, a monetary value based on a combination of the result of the slot-style game and the result of the bonus game

6. The method of claim 5, wherein the combination comprises an addition

7. The method of claim 1, wherein the populating of the first one of the bonus value accumulation areas associated with the first one of the plurality of slot reels, comprises:
causing, by the processing device and via the game output interface, an outputting of an animation representing a movement of a graphical aspect of the first bonus symbol to the respective first one of the bonus value accumulation areas.

8. The method of claim 1, wherein the populating of the first one of the bonus value accumulation areas associated with the first one of the plurality of slot reels, comprises:
assigning a value to the first one of the bonus value accumulation areas.

9. The method of claim 1, wherein the determining that the bonus game is triggered, comprises:
determining, by the processing device, that greater than a threshold number of the plurality of symbols comprise a bonus game trigger symbol.

10. The method of claim 9, wherein the bonus game trigger symbol comprises the first bonus symbol.

11. The method of claim 9, wherein the threshold number comprises three.

12. The method of claim 1, wherein the determining of the outcome of the bonus game defining the selection of the first one of the bonus value accumulation areas from the plurality of bonus value accumulation areas, comprises:
determining a subset of the plurality of bonus value accumulation areas that are eliminated from the bonus game; and
determining that the first one of the bonus value accumulation areas is the last value accumulation area remaining in the bonus game.

13. The method of claim 1, further comprising:
receiving an indication of a request from a player of the slot-style game, the request defining a reallocation of values assigned to the bonus value accumulation areas; and
reallocating, by the processing device and in response to the request from the player, the values assigned to the bonus value accumulation areas.

14. The method of claim 13, wherein the reallocating occurs after the determining that the bonus game is triggered.

15. The method of claim 13, wherein the reallocating comprises assigning player-defined values to each bonus value accumulation area.

16. The method of claim 13, wherein the reallocating comprises applying a set of reallocation rules identified by the request.

17. The method of claim 16, wherein the set of reallocation rules comprises one of (i) a random reallocation rule, and (ii) an even distribution reallocation rule.

18. A system, comprising:
a processing device; and
a memory device in communication with the processing device, the memory device storing instructions that when executed by the processing device result in:
determining a plurality of symbols indicative of an outcome of a slot-style game, each symbol of the plurality of symbols being represented at a particular position on one of a plurality of slot reels of a game output interface, each slot reel of the game interface being associated with a respective bonus value accumulation area;
determining, based on a paytable of the slot-style game and based on the positions of the plurality of symbols indicative of the outcome, a result associated with the outcome of the slot-style game;
determining that a first one of the plurality of symbols comprises a first bonus symbol represented at a first particular position on a first one of the plurality of slot reels;
populating, based on the determining that the first one of the plurality of symbols comprises the first bonus symbol represented at the first particular position on the first one of the plurality of slot reels, a first one of the bonus value accumulation areas associated with the first one of the plurality of slot reels;
determining, after the populating, that a bonus game is triggered;
determining an outcome of the bonus game, the outcome defining a selection of the first one of the bonus value accumulation areas from the plurality of bonus value accumulation areas;
determining, based on the populating, a result associated with the outcome of the bonus game; and
causing, via the game output interface, an outputting of an indication of least one of: (i) the result of the slot-style game, and (ii) the result of the bonus game.

19. A computer-readable memory device storing instructions that when executed by a processing device result in:
determining a plurality of symbols indicative of an outcome of a slot-style game, each symbol of the plurality of symbols being represented at a particular position on one of a plurality of slot reels of a game output interface, each slot reel of the game interface being associated with a respective bonus value accumulation area;
determining, based on a paytable of the slot-style game and based on the positions of the plurality of symbols indicative of the outcome, a result associated with the outcome of the slot-style game;
determining that a first one of the plurality of symbols comprises a first bonus symbol represented at a first particular position on a first one of the plurality of slot reels;
populating, based on the determining that the first one of the plurality of symbols comprises the first bonus symbol represented at the first particular position on the first one of the plurality of slot reels, a first one of the bonus value accumulation areas associated with the first one of the plurality of slot reels;
determining, after the populating, that a bonus game is triggered;
determining an outcome of the bonus game, the outcome defining a selection of the first one of the bonus value accumulation areas from the plurality of bonus value accumulation areas;
determining, based on the populating, a result associated with the outcome of the bonus game; and
causing, via the game output interface, an outputting of an indication of least one of: (i) the result of the slot-style game, and (ii) the result of the bonus game.
